(19) United States
(12) Patent Application Publication
(10) Pub. No.: US 2026/0297440 A1
(43) Pub. Date: Oct. 1, 2026

(54) A PROCESS FOR PURIFYING A PYROLYSIS OIL

(71) Applicant: BASE SE, Ludwigshafen am Rhein (DE)

(72) Inventors: Oliver PILARSKI, Ludwigshafen am Rhein (DE); Armin LANGE DE OLIVEIRA, Heidelberg (DE); Gisela HIEBER, Ludwigshafen am Rhein (DE); Daniel KOEPKE, Ludwigshafen am Rhein (DE); Monica HAAG, Ludwigshafen am Rhein (DE); Mathias FEYEN, Ludwigshafen am Rhein (DE); Michael SCHREIBER, Ludwigshafen am Rhein (DE); Andreas MELZER, Ludwigshafen am Rhein (DE); Steffen MUELLER, Ludwigshafen am Rhein (DE); Felix HUELSMANN, Ludwigshafen am Rhein (DE)

(21) Appl. No.: 19/474,435

(22) PCT Filed: Apr. 12, 2024
(86) PCT No.: PCT/EP2024/060026

§ 371 Date: Oct. 10, 2025

(30) Foreign Application Priority Data
Apr. 13, 2023 (EP) 23167692.5
Apr. 19, 2023 (EP) 23168808.6

(51) Int. Cl. C10G 53/06; B01D 11/04; C08J 11/08; C10G 53/12

(52) U.S. Cl. CPC C10G 53/06; B01D 11/0488; B01D 11/0492; C08J 11/08; C10G 53/12; C08J 2367/00; C10G 2300/1003

(57) ABSTRACT

A method for manufacture of polyesters with recycle content is described in various aspects. The methods of the present disclosure effectively and cost-efficiently incorporates recycled DMT into existing TPA-based polyester manufacturing systems. Recycle feed compositions for manufacture of polyesters with recycle content and recycled content polyesters are also described.

The present invention relates to a process for purifying a pyrolysis oil and a unit for carrying out said process. The present invention further relates to a purified pyrolysis oil obtainable or obtained by said process.

Currently, plastic waste is still largely landfilled or incinerated for heat generation. Chemical recycling is an attractive way to convert waste plastic material and tires into useful chemicals. An important technique for chemically recycling plastic waste or tires is pyrolysis. The pyrolysis is a thermal degradation of waste material in an inert atmosphere and yields value added products such as pyrolysis gas, liquid pyrolysis oil and char (residue), wherein pyrolysis oil is the major product. The pyrolysis gas and char can be used as fuel for generating heat, e.g. for reactor heating purposes. The pyrolysis oil can be used as source for syngas production and/or processed into chemical feedstock such as ethylene, propylene, C4 cuts, etc. for example in a (steam) cracker.

Typically, the plastic waste and tires are composed of different types of polymers. The polymers are often composed of carbon and hydrogen in combination with other elements such as chlorine, bromine, fluorine, sulfur, oxygen and nitrogen that complicate recycling efforts. The pyrolysis oil obtained from these materials if not purified can damage by corrosion for example during storage or cracking. Therefore, a high quality pyrolysis oil is preferred as feedstock to prevent corrosion problems in downstream refinery processes.

US 2021/0277324 A1 discloses the purification of a pyrolysis oil by treating the oil with sodium hydroxide at a temperature of 240° C. WO 2014/165859 A1 discloses a method for purifying a pyrolysis oil by reducing contaminants content such as acids, metals. Further, WO 2020/178599 A1 discloses a process for upgrading a pyrolysis oil comprising washing with water the pyrolysis oil, followed by washing the pyrolysis oil with an alkane and treating the obtained organic phase with an upgrading solution comprising polar organic solvent.

However, there is still a need to provide improved process for purifying pyrolysis oil obtained from waste materials, such as plastics and tires. In particular, there is still a need to provide improved process which permits to reduce the corrosion in the downstream processes and/or storage.

Therefore, there is a need to provide a process for purifying pyrolysis oils, preferably obtained from waste material, in particular by reducing the total acid number as well as oxygen content.

Indeed, there is a need to provide high value purified pyrolysis oils while using an economic process.

Therefore, the present invention relates to a process for purifying a pyrolysis oil, the process comprising:
(i) providing a stream F0 comprising a pyrolysis oil;
(ii) subjecting the stream F0 provided in (i) to extraction in at least one extraction zone Z_{E}, obtaining a stream F1 comprising the extracted pyrolysis oil, wherein (ii) comprises:
   (ii.1) introducing F0 into an extraction unit UM1 comprised in Z_{E};
   (ii.2) bringing in contact F0 with water and a base B in UM1 at a temperature T1 in the range of from 10 to 200° C., obtaining a mixture M1 comprising an aqueous phase P_{A}(1) and an organic phase P_{O}(1), the pH of the aqueous phase P_{A}(1) of M1 being in the range of from 7.5 to 11;
   (ii.3) passing the mixture M1 obtained according to (ii.2) into a liquid-liquid separation unit US1 comprised in Z_{E}, US1 being located downstream of UM1, obtaining a stream F_{A}(1) comprising P_{A}(1) and a stream F1 comprising P_{O}(1) being the extracted pyrolysis oil;
   (ii.4) removing F1 from Z_{E};
(iii) subjecting the stream F1 provided in (ii) to washing in at least one washing zone Z_{W}, Z_{W} being located downstream of Z_{E}, obtaining a stream F2 comprising the purified pyrolysis oil.

Generally, from 1 to 100 weight-% or from 5 to 100 weight-% or from 10 to 100 weight-% or from 20 to 100 weight-% or from 30 to 100 weight-% or from 40 to 100 weight-% or from 50 to 100 weight-% or from 60 to 100 weight-% or from 70 to 100 weight-% or from 80 to 100 weight-% or from 90 to 100 weight-% of F0 may consist of pyrolysis oil.

Preferably from 95 to 100 weight-%, more preferably from 98 to 100 weight-%, more preferably from 99 to 100 weight-%, of F0 consist of pyrolysis oil.

It is possible that from 99.5 to 100 weight-% or from 99.8 to 100 weight-% or from 99.9 weight-% of F0 consist of pyrolysis oil.

In the context of the present invention, the pyrolysis oil to be purified can have any oxygen content.

Preferably, the pyrolysis oil according to (i) has a total acid number (TAN) in the range of from 0.5 to 60 mg KOH/g (F0), more preferably 1 to 40 mg KOH/g (F0), preferably in the range of from 3 to 20 mg KOH/g (F0), determined as described in Reference Example 3.

Preferably, the pyrolysis oil according to (i) has an oxygen content in the range of from 0 to 15 g(O)/100 g (F0), more preferably in the range of from 0.5 to 10 g(O)/100 g (F0), more preferably in the range of from 0.5 to 5 g(O)/100 g (F0), more preferably in the range of from 0.5 to 2 g(O)/100 g (F0), determined as described in Reference Example 4.

Preferably, the pyrolysis oil according to (i) has a total chlorine content in the range of from 30 to 3,000 wppm (ppm by weight), more preferably from 30 to 500 wppm, more preferably from 30 to 300 wppm, determined as described in Reference Example 1.1.

Preferably, the pyrolysis oil according to (i) has a chloride content of at most 40 wppm, more preferably in the range of from 0 to 30 wppm, determined as described in Reference Example 1.2.

Preferably, the pyrolysis oil according to (i) has a nitrogen content in the range of from 50 to 20,000 wppm (ppm by weight), more preferably from 50 to 5,000 wppm, more preferably from 100 to 4,000 wppm, determined as described in Reference Example 2.

Preferably, the pyrolysis oil according to (i) has an iron content in the range of from 1 to 100 wppm (ppm by weight), preferably from 10 to 50 wppm, determined as described in Reference Example 6.

Preferably, the pyrolysis oil according to (i) has a zinc content in the range of from 1 to 100 wppm (ppm by weight), preferably from 1 to 50 wppm, determined as described in Reference Example 6.

Preferably, the pyrolysis oil according to (i) has a tin content in the range of from 1 to 100 wppm (ppm by weight), preferably from 1 to 50 wppm, determined as described in Reference Example 6.

Preferably, the pyrolysis oil provided in (i) is obtained from the pyrolysis of waste material, the waste material being plastic waste material or tire waste material or biomass waste.

Preferably, (i) comprises
(i.1) removing a pyrolysis oil from a storage tank or a truck.

Preferably, (ii.2) comprises
(ii.2.1) introducing water into UM1 comprised in Z_{E};
(ii.2.2) bringing in contact, more preferably mixing, F0 with water into UM1, obtaining a mixture PM1 comprising water and the pyrolysis oil;
(ii.2.3) introducing B into UM1 and bringing in contact, more preferably mixing, B with the mixture PM1 obtained in (ii.2.2) into UM1, obtaining a mixture M1 comprising an aqueous phase P_{A}(1) and an organic phase P_{O}(1), the pH of the aqueous phase P_{A}(1) of M1 being in the range of from 7.5 to 11, more preferably in the range of from 8 to 10.

Preferably, (ii.2) comprises
(ii.2.1) introducing water into UM1 comprised in Z_{E};
(ii.2.2) bringing in contact, more preferably mixing, F0 with water into Z_{E}, obtaining a mixture PM1 comprising water and the pyrolysis oil, wherein the aqueous phase of PM1 having a pH value pH(PM1), more preferably measured by a pH-sensor in UM1;
(ii.2.3) adjusting the pH of the aqueous phase of PM1 by introducing B into UM1 by bringing in contact, more preferably mixing, B with M1 obtained in (ii.2.2) into UM1, obtaining a mixture M1 comprising an aqueous phase P_{A}(1) and an organic phase P_{O}(1), the pH of the aqueous phase P_{A}(1) of M1>pH(PM1), the pH of P_{A}(1) being in the range of from 7.5 to 11, more preferably in the range of from 8 to 10.

Alternatively, preferably (ii.2) comprises
(ii.2.1′) mixing water and B, obtaining a mixture M0 of water and B having a pH(M0) in the range of from 12 to 14;
(ii.2.2′) introducing M0 obtained according to (ii.2.1′) into UM1 and bringing in contact, more preferably mixing, F0 with M0, obtaining a mixture M1 comprising an aqueous phase P_{A}(1) and an organic phase P_{O}(1), the pH of the aqueous phase P_{A}(1) of M1 being in the range of from 7.5 to 11, more preferably in the range of from 8 to 10.

In the context of the present invention, preferably, the extraction unit UM1 is one or more of a stirred vessel, a mixing pump and a static mixer, more preferably a stirred vessel.

In the context of the present invention, the skilled person depending on the nature/type of the pyrolysis oil will know which temperature to apply in order to bring in contact the stream F0, water and the base B in the liquid phase according to its general knowledge.

Preferably, bringing in contact, preferably mixing, according to (ii.2) is performed at a temperature T1 in the range of from 10 to 95° C., more preferably in the range of from 15 to 85° C., more preferably in the range of from 20 to 80° C.

Preferably, bringing in contact, more preferably mixing, according to (ii.2) is performed at a pressure p1 in the range of from 0.8 to 1.2 bar (abs), more preferably in the range of from 0.9 to 1.1 bar (abs). More preferably, when T1≤95° C., bringing in contact, more preferably mixing, according to (ii.2) is performed at a pressure p1 in the range of from 0.8 to 1.2 bar (abs), more preferably in the range of from 0.9 to 1.1 bar (abs), more preferably at about 1 bar (abs). Alternatively, bringing in contact, more preferably mixing, according to (ii.2) is performed at a pressure p1 in the range of from 0.5 to 5 bar (abs), more preferably in the range of from 0.7 to 3 bar (abs), more preferably in the range of from 0.9 to 2 bar (abs).

In the context of the present invention, when T1>95° C., the pressure p1 is in the range of from 1 to 16 bar (abs).

Preferably, the base B is one or more of an alkali metal compound, an alkaline earth metal compound (e.g. alkaline earth metal oxide and/or hydroxide such as calcium hydroxide) and ammonia. More preferably B is an alkali metal compound being one or more of potassium hydroxide, sodium hydroxide, potassium carbonate, sodium carbonate, potassium bicarbonate and sodium bicarbonate, more preferably one or more of potassium hydroxide, sodium hydroxide, potassium carbonate and sodium carbonate, more preferably one or more of potassium hydroxide and sodium hydroxide, more preferably potassium hydroxide or sodium hydroxide, more preferably potassium hydroxide.

Alternatively, the base B is one or more of a potassium compound, more preferably one or more of potassium hydroxide, potassium bicarbonate and potassium carbonate, more preferably potassium hydroxide or potassium carbonate, more preferably potassium hydroxide.

Preferably, water used in (ii) is demineralized water.

Preferably, according to (ii.2), the weight ratio of water to F0 is in the range of from 0.05:1 to 2:1, more preferably in the range of from 0.1:1 to 1.5:1, more preferably in the range of from 0.1:1 to 1.2:1, more preferably in the range of from 0.1:1 to 0.5:1, more preferably in the range of from 0.2:1 to 0.5:1, more preferably in the range of from 0.25:1 to 0.5:1, more preferably in the range of from 0.3:1 to 0.5:1.

Preferably, the liquid-liquid separation unit US1 is one or more of a hydrocyclone, a settler tank and a centrifuge, more preferably a decanter, a hydrocyclone, a settler tank or a centrifuge, more preferably a settler tank.

In the context of the present invention, UM1 and US1 are two distinct units.

Preferably, the separation in US1 according to (ii.3) is performed at a temperature in the range of from 10 to 95° C., more preferably in the range of from 15 to 85° C., more preferably in the range of from 20 to 80° C.

Preferably, prior to passing M1 into US1 according to (ii.3), the process further comprises passing M1 into a solid-liquid separation unit SLS1 for removing solids, if any, in M1.

Preferably, the solid-liquid separation unit SLS1 is one or more of a filter and a centrifuge.

The solid-liquid-separation can be performed with a filter using a differential pressure as driving force or with a centrifuge working with centrifugal force to separate liquid and solids.

Using a filter means often a discontinuous solid-liquid-separation, where the pressure difference is increasing with increasing filtration time. After a certain amount of pressure difference or filtration time, the solids have to be removed from the filter via a backflush by a fluid or gas or a mixture of both (e.g. disposal filter, backflush filter) or by an automatic system (e.g. automatic cleaning filter) or rotating or vibrating (e.g. pressure leaf filter, candle filter, filter press). During the removal of the solids, a second parallel filter is started operation until a certain pressure difference or filtration time is reached, where the solid emptied filter will be in operation again. The filtration can be performed with disposal filter (e.g. bag filter, filter with filter sheets or membranes), where the solids are removed by back flushing or the solids remain on the filter cloth, which lead to a substitution of the filter after a certain pressure difference or operational time. The filtration can be supported by the use of a filter aid to improve the filtration behavior. That can lead to a potential usage of a continuous filter (e.g. belt filter, drum filter).

Centrifuges can be used for a discontinuous solid-liquid-separation or continuous solid-liquid-separation depending on the centrifuge type. Centrifuges (e.g. decanter centrifuge, separator centrifuge) can be used in a 2 phase (solid-liquid) or 3 phase-system of two liquid phases and solids to separate the solids from the liquid or liquids and the liquid from the liquid. In a separator centrifuge the solids have to be released after the centrifuge loaded to a maximum of solids (discontinuous) compared to a decanter centrifuge, where the solids are continuously separated and removed. The centrifugation can be supported by the use of flocculants to improve the centrifugation behavior.

Alternatively, preferably, between UM1 and US1, no separation unit is located. In this regard, M1 removed from UM1 is passed directly into US1.

It is conceivable that the units UM1 and US1 be juxtaposed for example forming a mixer-settler.

Preferably, the process further comprises
passing the stream F_{A}(1) comprising P_{A}(1) obtained according to (ii.3) in a separation unit USA1, preferably a settler tank, obtaining an aqueous stream SA1 comprising water.

Preferably, the process further comprises one or more purification treatment step for purifying SA1.

Preferably, the process further comprises recycling SA1, more preferably purified SA1 (water), in UM1.

Preferably from 80 to 100 weight-%, more preferably from 85 to 100 weight-%, of F_{A}(1) consists of water.

Alternatively, preferably, the process further comprises recycling at least a portion of water comprised in F_{A}(1) obtained according to (ii.3) into UM1.

In the context of the present invention, preferably, no organic solvent is used in (ii).

It is conceivable that the process further comprises, after (ii) and prior to (iii), an acidic treatment. In particular, the acidic treatment may comprise adding one or more acidic component to F1.

It is conceivable that (ii) of the process of the present invention further comprises one or more subsequent extraction in Z_{E}.

Preferably, the process further comprises, when crud is formed at the interphase of P_{A}(1) and P_{O}(1) in US1, purging said crud from US1.

Preferably, US1 comprises a means for purging the optional crud formed at the interphase of P_{A}(1) and P_{O}(1).

Preferably, the purged crud is subjected to one or more purification treatments. For example, the crud can be treated with a filter and/or a centrifuge.

As to (iii), according to a first alternative, (iii) preferably comprises
(iii.1) introducing F1 into a washing unit UM2 comprised in Z_{W};
(iii.2) bringing in contact F1 with water in UM2 at a temperature T2 in the range of from 10 to 95° C., obtaining a mixture M2 comprising an aqueous phase P_{A}(2) and an organic phase P_{O}(2), the pH of the aqueous phase P_{A}(2) of M2 being in the range of from 7.5 to 11, pH of P_{A}(2)<pH of P_{A}(1);
(iii.3) passing the mixture M2 obtained according to (iii.2) into a liquid-liquid separation unit US2 comprised in Z_{W}, US2 being located downstream of UM2, obtaining a stream F_{A}(2) comprising P_{A}(2) and a stream F2 comprising P_{O}(2) being the purified pyrolysis oil.

Preferably, the present invention relates to a process for purifying a pyrolysis oil, the process comprising:
(i) providing a stream F0 comprising a pyrolysis oil;
(ii) subjecting the stream F0 provided in (i) to extraction in at least one extraction zone Z_{E}, obtaining a stream F1 comprising the extracted pyrolysis oil, wherein (ii) comprises:
   (ii.1) introducing F0 into an extraction unit UM1 comprised in Z_{E};
   (ii.2) bringing in contact F0 with water and a base B in UM1 at a temperature T1 in the range of from 10 to 200° C., obtaining a mixture M1 comprising an aqueous phase P_{A}(1) and an organic phase P_{O}(1), the pH of the aqueous phase P_{A}(1) of M1 being in the range of from 7.5 to 11;
   (ii.3) passing the mixture M1 obtained according to (ii.2) into a liquid-liquid separation unit US1 comprised in Z_{E}, US1 being located downstream of UM1, obtaining a stream F_{A}(1) comprising P_{A}(1) and a stream F1 comprising P_{O}(1) being the extracted pyrolysis oil;
   (ii.4) removing F1 from Z_{E};
(iii) subjecting the stream F1 provided in (ii) to washing in at least one washing zone Z_{W}, Z_{W} being located downstream of Z_{E}, obtaining a stream F2 comprising the purified pyrolysis oil, wherein (iii) comprises
   (iii.1) introducing F1 into a washing unit UM2 comprised in Z_{W};
   (iii.2) bringing in contact F1 with water in UM2 at a temperature T2 in the range of from 10 to 95° C., obtaining a mixture M2 comprising an aqueous phase P_{A}(2) and an organic phase P_{O}(2), the pH of the aqueous phase P_{A}(2) of M2 being in the range of from 7.5 to 11, pH of P_{A}(2)<pH of P_{A}(1);
   (iii.3) passing the mixture M2 obtained according to (iii.2) into a liquid-liquid separation unit US2 comprised in Z_{W}, US2 being located downstream of UM2, obtaining a stream F_{A}(2) comprising P_{A}(2) and a stream F2 comprising P_{O}(2) being the purified pyrolysis oil.

Such alternative is illustrated by FIGS. 1, 2 and 4.

Preferably, the washing unit UM2 is one or more of a stirred vessel, a mixing pump and a static mixer, more preferably a stirred vessel.

Preferably, according to (iii.2), the weight ratio of water to F1 is in the range of from 0.05:1 to 2:1, more preferably in the range of from 0.1:1 to 1.5:1, more preferably in the range of from 0.1:1 to 1.2:1, more preferably in the range of from 0.1:1 to 0.5:1.

Preferably, when B is KOH or NaOH, the weight ratio of water to F1 is in the range of from 0.05:1 to 2:1, more preferably in the range of from 0.1:1 to 1.5:1, more preferably in the range of from 0.1:1 to 1.2:1, more preferably in the range of from 0.1:1 to 0.5:1.

Preferably, T2 is in the range of from 15 to 85° C., more preferably in the range of from 20 to 80° C.

Preferably 0.75 T1≤T2≤1.25 T1, more preferably 0.90 T1≤T2≤1.1 T1.

Preferably, water used in (iii) is demineralized water.

Preferably, the liquid-liquid separation unit US2 is one or more of a hydrocyclone, a settler tank, and a centrifuge, more preferably a hydrocyclone, a settler tank or a centrifuge, more preferably a settler tank or centrifuge.

Preferably, UM2 and US2 are two distinct units.

Preferably, the separation in US2 according to (iii.3) is performed at a temperature in the range of from 10 to 85° C., more preferably in the range of from 15 to 85° C., more preferably in the range of from 20 to 80° C.

Optionally, prior to passing M2 into US2 according to (iii.3), the process further comprises passing M2 into a solid-liquid separation unit SLS2 for removing solids, if any, in M2.

Preferably, the solid-liquid separation unit SLS2 is one or more of a filter and a centrifuge.

The solid-liquid-separation can be performed with a filter using a differential pressure as driving force or with a centrifuge working with centrifugal force to separate liquid and solids.

Using a filter means often a discontinuous solid-liquid-separation, where the pressure difference is increasing with increasing filtration time. After a certain amount of pressure difference or filtration time, the solids have to be removed from the filter via a backflush by a fluid or gas or a mixture of both (e.g. disposal filter, backflush filter) or by an automatic system (e.g. automatic cleaning filter) or rotating or vibrating (e.g. pressure leaf filter, candle filter, filter press). During the removal of the solids, a second parallel filter is started operation until a certain pressure difference or filtration time is reached, where the solid emptied filter will be in operation again. The filtration can be performed with disposal filter (e.g. bag filter, filter with filter sheets or membranes), where the solids are removed by back flushing or the solids remain on the filter cloth, which lead to a substitution of the filter after a certain pressure difference or operational time. The filtration can be supported by the use of a filter aid to improve the filtration behavior. That can lead to a potential usage of a continuous filter (e.g. belt filter, drum filter).

Centrifuges can be used for a discontinuous solid-liquid-separation or continuous solid-liquid-separation depending on the centrifuge type. Centrifuges (e.g. decanter centrifuge, separator centrifuge) can be used in a 2 phase (solid-liquid) or 3 phase-system of two liquid phases and solids to separate the solids from the liquid or liquids and the liquid from the liquid. In a separator centrifuge the solids have to be released after the centrifuge loaded to a maximum of solids (discontinuous) compared to a decanter centrifuge, where the solids are continuously separated and removed. The centrifugation can be supported by the use of flocculants to improve the centrifugation behavior.

Alternatively, preferably, between UM2 and US2, no separation unit is located. In this regard, M2 removed from UM2 is passed directly into US2.

It is conceivable that the units UM2 and US2 be juxtaposed for example forming a mixer-settler.

Preferably, the process further comprises, when crud is formed at the interphase of P_{A}(2) and P_{O}(2) in US2, purging said crud from US2.

As to (iii), according to a second alternative, (iii) preferably comprises
(iii.1′) introducing F1 into an extraction column UM+US comprised in Z_{W};
(iii.2′) introducing water into UM+US;
(iii.3′) bringing in contact F1 with water in UM+US at a temperature T2′ in the range of from 10 to 95° C., obtaining a stream F_{A}(2) comprising an aqueous phase P_{A}(2), the pH of the aqueous phase P_{A}(2) of M2 being in the range of from 7.5 to 11, pH of P_{A}(2)<pH of P_{A}(1), and obtaining a stream F2 comprising the purified pyrolysis oil. Such alternative is illustrated by FIG. 3.

Preferably, the present invention relates to a process for purifying a pyrolysis oil, the process comprising:
(i) providing a stream F0 comprising a pyrolysis oil;
(ii) subjecting the stream F0 provided in (i) to extraction in at least one extraction zone Z_{E}, obtaining a stream F1 comprising the extracted pyrolysis oil, wherein (ii) comprises:
   (ii.1) introducing F0 into an extraction unit UM1 comprised in Z_{E};
   (ii.2) bringing in contact F0 with water and a base B in UM1 at a temperature T1 in the range of from 10 to 200° C., obtaining a mixture M1 comprising an aqueous phase P_{A}(1) and an organic phase P_{O}(1), the pH of the aqueous phase P_{A}(1) of M1 being in the range of from 7.5 to 11;
   (ii.3) passing the mixture M1 obtained according to (ii.2) into a liquid-liquid separation unit US1 comprised in Z_{E}, US1 being located downstream of UM1, obtaining a stream F_{A}(1) comprising P_{A}(1) and a stream F1 comprising P_{O}(1) being the extracted pyrolysis oil;
   (ii.4) removing F1 from Z_{E};
(iii) subjecting the stream F1 provided in (ii) to washing in at least one washing zone Z_{W}, Z_{W} being located downstream of Z_{E}, obtaining a stream F2 comprising the purified pyrolysis oil, wherein (iii) comprises
   (iii.1′) introducing F1 into an extraction column UM+US comprised in Z_{W};
   (iii.2′) introducing water into UM+US;
   (iii.3′) bringing in contact F1 with water in UM+US at a temperature T2′ in the range of from 10 to 95° C., obtaining a stream F_{A}(2) comprising an aqueous phase P_{A}(2), the pH of the aqueous phase P_{A}(2) of M2 being in the range of from 7.5 to 11, pH of P_{A}(2)<pH of P_{A}(1), and obtaining a stream F2 comprising the purified pyrolysis oil.

Preferably, according to (iii.3′), the weight ratio of water to F1 is in the range of from 0.05:1 to 2:1, more preferably in the range of from 0.1:1 to 1.5:1, more preferably in the range of from 0.1:1 to 1.2:1, more preferably in the range of from 0.1:1 to 0.5:1.

Preferably, T2′ is in the range of from 15 to 85° C., more preferably in the range of from 20 to 80° C.

Preferably 0.75 T1≤T2′≤1.25 T1, more preferably 0.90 T1≤T2′≤1.1 T1.

Preferably, (iii) is performed at a pressure p2 in the range of from 0.75 to 1.25 bar (abs), more preferably in the range of from 0.9 to 1.1 bar (abs), more preferably at about 1 bar (abs).

Preferably from 90 to 100 weight-%, more preferably from 95 to 100 weight-%, of F_{A}(2) consists of water.

In the context of the present invention, it is preferred that the process further comprising recycling at least a portion of water comprised in F_{A}(2) obtained according to (iii.3) in (ii.2) and/or (iii.2); or recycling at least a portion of water comprised in F_{A}(2) obtained according to (iii.3′) in (ii.2) and/or (iii.2′).

Preferably, recycling at least a portion of water comprised in F_{A}(2) obtained according to (iii.3) in (ii.2) and/or (iii.2) comprises passing the at least portion of water comprised in F_{A}(2) obtained according to (iii.3) into UM1 and/or UM2.

Preferably, recycling at least a portion of water comprised in F_{A}(2) obtained according to (iii.3′) in (ii.2) and/or (iii.2′) comprises passing the at least portion of water comprised in F_{A}(2) obtained according to (iii.3′) into UM1 and/or UM+US.

Preferably, water used in (iii) is demineralized water.

Preferably, no organic solvent is used in (iii).

Preferably, no base is added in (iii), the base being one or more of an alkali metal compound (such as potassium hydroxide, sodium hydroxide, potassium carbonate, sodium carbonate, potassium bicarbonate and sodium bicarbonate more preferably one or more of potassium hydroxide, sodium hydroxide, potassium carbonate and sodium carbonate), an alkaline earth metal compound and ammonia.

Preferably, the stream F2 comprising the purified pyrolysis oil obtained according to (iii) has a total acid number (TAN) which is lower than the TAN of the pyrolysis oil provided in (i).

Preferably, the stream F2 comprising the purified pyrolysis oil obtained according to (iii) has a TAN in the range of from 0 to 20 mg KOH/g (F2), more preferably in the range of from 0 to 10 mg KOH/g (F2), more preferably in the range of from 0 to 4 mg KOH/g (F2), determined as described in Reference Example 3.

Preferably, the stream F2 comprising the purified pyrolysis oil obtained according to (iii) has an oxygen content equal to or lower than, more preferably lower than, the oxygen content of the pyrolysis oil provided in (i).

Preferably, the stream F2 comprising the purified pyrolysis oil has an oxygen content in the range of from 0 to 2 g(O)/100 g (F2), determined as described in Reference Example 4.

It is preferred according to the present invention that the stream F2 comprising the purified pyrolysis oil obtained according to (iii) has a reduced iron content compared to the pyrolysis oil provided in (i). For example, the reduction of the iron (Fe) content in F2 compared to the pyrolysis oil provided in (i) can be in the range of from 1 to 100%, or in the range of from 5 to 95%, or in the range of from 40 to 90%.

It is conceivable according to the present invention that the stream F2 comprising the purified pyrolysis oil obtained according to (iii) has a reduced total chlorine content and/or chloride content compared to the pyrolysis oil provided in (i). For example, the reduction of the total chlorine content and/or chloride content in F2 compared to the pyrolysis oil provided in (i) can be in the range of from 1 to 100%, or in the range of from 1 to 80% or in the range of from 10 to 50%.

It is conceivable according to the present invention that the stream F2 comprising the purified pyrolysis oil obtained according to (iii) has a reduced tin (Sn) content compared to the pyrolysis oil provided in (i). For example, the reduction of the tin content in F2 compared to the pyrolysis oil provided in (i) can be in the range of from 1 to 100%, or in the range of from 5 to 80%, or in the range of from 20 to 80%.

It is conceivable according to the present invention that the stream F2 comprising the purified pyrolysis oil obtained according to (iii) has a reduced zinc (Zn) content compared to the pyrolysis oil provided in (i). For example, the reduction of the zinc content in F2 compared to the pyrolysis oil provided in (i) can be in the range of from 1 to 100%, or in the range of from 5 to 80%, or in the range of from 20 to 80%.

It is conceivable according to the present invention that the stream F2 comprising the purified pyrolysis oil obtained according to (iii) has a nitrogen content lower to the nitrogen content of the pyrolysis oil provided in (i).

It is conceivable according to the present invention that the stream F2 comprising the purified pyrolysis oil obtained according to (iii) has a sulfur content lower to the sulfur content of the pyrolysis oil provided in (i).

Preferably, from 95 to 100 weight-%, more preferably from 98 to 100 weight-%, more preferably from 99 to 100 weight-%, more preferably from 99.5 to 100 weight-%, of F2 consist of the purified pyrolysis oil.

Optionally, the process of the present invention further comprises one or more subsequent washing in Z_{W}. According to this option, the process further comprises
(iv) subjecting at least a portion of the stream F2 obtained according to (iii) to one or more subsequent washing in Z_{W}, wherein (iv) comprises:
   (iv.1) optionally introducing at least a portion of F2, preferably F2, obtained according to (iii) into a washing unit UM3 comprised in Z_{W}, UM3 being located downstream of US2;
      bringing in contact the at least portion of F2, preferably F2, with water in UM3 at a temperature T3 in the range of from 10 to 95° C., obtaining a mixture M3 comprising an aqueous phase P_{A}(3) and an organic phase P_{O}(3) of M3 being in the range of from 7.5 to 11, pH of P_{A}(3)<pH of P_{A}(1);
      passing the mixture M3 in a liquid-liquid separation unit US3 comprised in Z_{W}, US3 being located downstream of UM3, obtaining a stream F_{A}(3) comprising P_{A}(3) and a stream F3 comprising P_{O}(3) being the purified pyrolysis oil;
   (iv.2) introducing at least a portion of F2, preferably F2, obtained according to (iii), or at least a portion of F3, preferably F3, obtained according to (iv.1), into a washing unit UM4 comprised in Z_{W}, UM4 being located downstream of US3;
   (iv.3) bringing in contact the at least portion of F2, preferably F2, or the at least portion of F3, preferably F3, with water in UM4 at a temperature T4 in the range of from 10 to 95° C., obtaining a mixture M4 comprising an aqueous phase P_{A}(4) and an organic phase P_{O}(4), the pH of the aqueous phase P_{A}(4) of M4 being in the range of from 7.5 to 11, pH of P_{A}(4)<pH of P_{A}(1);
   (iv.4) passing the mixture M4 obtained according to (iv.3) in a liquid-liquid separation unit US4 comprised in Z_{W}, US4 being located downstream of UM4, obtaining a stream F_{A}(4) comprising P_{A}(4) and a stream F4 comprising P_{O}(4) being the purified pyrolysis oil.

Said option is illustrated for example by FIG. 4.

Preferably, pH of P_{A}(3)<pH of P_{A}(2).

Preferably, pH of P_{A}(4)<pH of P_{A}(2).

Preferably, pH of P_{A}(4)<pH of P_{A}(3). More preferably, pH of P_{A}(4)<pH of P_{A}(3)<pH of P_{A}(2)<pH of P_{A}(1).

Preferably, according to said option, the process further comprises recycling at least a portion of F_{A}(4) into UM2 and/or UM3 (if present).

Preferably from 90 to 100 weight-%, more preferably from 95 to 100 weight-%, of F_{A}(4) consists of water.

Preferably, UM4, if present, is one or more of a stirred vessel, a mixing pump and a static mixer, more preferably a stirred vessel.

Preferably, according to (iv.3), the weight ratio of water to the at least portion of F2, more preferably F2, or the at least portion of F3, more preferably F3, is in the range of from 0.05:1 to 2:1, more preferably in the range of from 0.1:1 to 1.5:1, more preferably in the range of from 0.1:1 to 1.2:1, more preferably in the range of from 0.1:1 to 0.5:1.

Preferably, T4 is in the range of from 15 to 85° C., more preferably in the range of from 20 to 80° C.

Preferably 0.75 T1≤T4≤1.25 T1, more preferably 0.90 T1≤T4≤1.1 T1.

Preferably, the liquid-liquid separation unit US4 is one or more of a hydrocyclone, a settler tank, and a centrifuge, more preferably a hydrocyclone, a settler tank or a centrifuge, more preferably a settler tank or centrifuge.

Preferably, UM4 and US4 are two distinct units.

Preferably, the separation in US4 according to (iv.4) is performed at a temperature in the range of from 10 to 85° C., more preferably in the range of from 15 to 85° C., more preferably in the range of from 20 to 80° C.

Preferably, prior to passing M4 in US4 according to (iv.4), the process further comprises passing M4 in a solid-liquid separation unit SLS4 for removing solids, if any, in M4.

Preferably, the solid-liquid separation unit SLS4 is one or more of a filter and a centrifuge.

The solid-liquid-separation can be performed with a filter using a differential pressure as driving force or with a centrifuge working with centrifugal force to separate liquid and solids. Using a filter means often a discontinuous solid-liquid-separation, where the pressure difference is increasing with increasing filtration time. After a certain amount of pressure difference or filtration time, the solids have to be removed from the filter via a backflush by a fluid or gas or a mixture of both (e.g. disposal filter, backflush filter) or by an automatic system (e.g. automatic cleaning filter) or rotating or vibrating (e.g. pressure leaf filter, candle filter, filter press). During the removal of the solids, a second parallel filter is started operation until a certain pressure difference or filtration time is reached, where the solid emptied filter will be in operation again. The filtration can be performed with disposal filter (e.g. bag filter, filter with filter sheets or membranes), where the solids are removed by back flushing or the solids remain on the filter cloth, which lead to a substitution of the filter after a certain pressure difference or operational time.

The filtration can be supported by the use of a filter aid to improve the filtration behavior. That can lead to a potential usage of a continuous filter (e.g. belt filter, drum filter).

Centrifuges can be used for a discontinuous solid-liquid-separation or continuous solid-liquid-separation depending on the centrifuge type. Centrifuges (e.g. decanter centrifuge, separator centrifuge) can be used in a 2 phase (solid-liquid) or 3 phase-system of two liquid phases and solids to separate the solids from the liquid or liquids and the liquid from the liquid. In a separator centrifuge the solids have to be released after the centrifuge loaded to a maximum of solids (discontinuous) compared to a decanter centrifuge, where the solids are continuously separated and removed. The centrifugation can be supported by the use of flocculants to improve the centrifugation behavior.

Alternatively, preferably, between UM4 and US4, no separation unit is located. In this regard, M4 removed from UM4 is passed directly into US4.

Preferably, when (iv.1) is performed, the process further comprises recycling at least a portion of F_{A}(3) into UM2.

Preferably from 90 to 100 weight-%, more preferably from 95 to 100 weight-%, of F_{A}(3) consists of water.

Preferably, UM3, if present, is one or more of a stirred vessel, a mixing pump and a static mixer, more preferably a stirred vessel.

Preferably, according to (iv.1), the weight ratio of water to the at least portion of F2, more preferably F2, is in the range of from 0.05:1 to 2:1, more preferably in the range of from 0.1:1 to 1.5:1, more preferably in the range of from 0.1:1 to 1.2:1, more preferably in the range of from 0.1:1 to 0.5:1.

Preferably, T3 is in the range of from 15 to 85° C., more preferably in the range of from 20 to 80° C.

Preferably 0.75 T1≤T3≤1.25 T1, more preferably 0.90 T1≤T3≤1.1 T1.

Preferably, the liquid-liquid separation unit US3 is one or more of a hydrocyclone, a settler tank and a centrifuge, more preferably a hydrocyclone, a settler tank or a centrifuge, more preferably a settler tank or centrifuge.

Preferably, UM3 and US3 are two distinct units.

Preferably, the separation in US3 according to (iv.1) is performed at a temperature in the range of from 10 to 85° C., more preferably in the range of from 15 to 85° C., more preferably in the range of from 20 to 80° C.

Preferably, prior to passing M3 in US3 according to (iv.1), the process further comprises passing M3 in a solid-liquid separation unit SLS3 for removing solids, if any, in M3.

Preferably, the solid-liquid separation unit SLS3 is one or more of a filter and a centrifuge.

Alternatively, preferably, between UM3 and US3, no separation unit is located. In this regard, M3 removed from UM3 is passed directly into US3.

Preferably, water used in (iv) is demineralized water.

Preferably, no organic solvent is used in (iv).

Preferably, no base is added in (iv), the base being one or more of an alkali metal compound (such as potassium hydroxide, sodium hydroxide, potassium carbonate, sodium carbonate, potassium bicarbonate and sodium bicarbonate more preferably one or more of potassium hydroxide, sodium hydroxide, potassium carbonate and sodium carbonate), an alkaline earth metal compound and ammonia.

Preferably, (iv) is performed at a pressure p3 in the range of from 0.75 to 1.25 bar (abs), more preferably in the range of from 0.9 to 1.1 bar (abs), more preferably at about 1 bar (abs).

In the context of the present invention, the process further comprises

(v) introducing F2 comprising the pyrolysis oil obtained according to (iii), optionally F4 obtained according to (iv), into at least one storage unit SU and storing said pyrolysis oil in SU.

Preferably, the storage unit SU is a storage tank, more preferably a storage tank made of one or more of steel and stainless steel, more preferably carbon steel and stainless steel.

Preferably, the process of the present invention further comprises
one or more of a dechlorination step, a hydrogenation step, a hydroprocessing step, a steam cracking step, a hydrocracking step, an adsorption step, a distillation step, a stripping step, and an aqueous extraction step.

Preferably, the process of the present invention is a continuous or semi-continuous process.

Preferably, the process of the present invention consists of (i), (ii), (iii) and optionally (iv) and optionally (v).

The present invention further relates to a unit for carrying out the process for purifying a pyrolysis oil according to the present invention, the unit comprising
at least one extraction zone Z_{E} comprising an extraction unit UM1 and a liquid-liquid separation unit US1, UM1 being located upstream of US1;
an inlet means for introducing F0 into Z_{E};
an outlet means for removing F1 from Z_{E};
an inlet means for introducing F0 into UM1;
an outlet means for removing M1 from UM1;
an inlet means for introducing M1 into US1;
an outlet means from removing F1 from US1;
at least one washing zone Z_{W}, located downstream of Z_{E},
an inlet means for introducing F1 into Z_{W};
an outlet means for removing F2 from Z_{W}.

Preferably, US1 comprises a means for purging the optional crud formed at the interphase of P_{A}(1) and P_{O}(1).

Preferably, according to the first alternative, Z_{W} comprises
a washing unit UM2;
a liquid-liquid separation unit US2, UM2 being located upstream of US2;
an inlet means for introducing F1 into UM2;
an inlet means for introducing water into UM2;
an outlet means for removing M2 from UM2;
an inlet means for introducing M2 into US2;
an outlet means from removing F2 from US2.

Optionally, Z_{W} further comprises a washing unit UM4, preferably a mixing unit, and a liquid-liquid separation unit US4, UM4 being located downstream of US2 and US4 being located downstream of UM4.

Optionally Z_{W} further comprises a washing unit UM3, preferably a mixing unit, and a liquid-liquid separation unit US3, UM3 being located downstream of US2 and upstream of UM4, US3 being located downstream of UM3 and upstream of UM4.

Preferably, according to the second alternative, Z_{W} comprises
an extraction column UM+US;
an inlet means for introducing F1 into UM+US;
an inlet means for introducing water into UM+US;
an outlet means from removing F2 from UM+US.

In the context of the present invention, preferably, the unit further comprises
one or more of a storage tank, a cracking zone, a dechlorination zone, an hydrogenation zone, a hydroprocessing zone, a stripping zone and a distillation zone.

The present invention further relates to a purified pyrolysis oil, obtainable or obtained by a process according to the present invention.

Preferably, the purified pyrolysis oil of the present invention has a total acid number (TAN) in the range of from 0 to 20 mg KOH/g (oil), more preferably in the range of from 0 to 10 mg KOH/g (oil), more preferably in the range of from 0 to 4 mg KOH/g (oil), more preferably in the range of from 0 to 1 mg KOH/g (oil), more preferably from 0 to less than 1 mg KOH/g (oil), determined as described in Reference Example 3.

Preferably, the purified pyrolysis oil of the present invention has an oxygen content in the range of from 0 to 2 g(O)/100 g (oil), determined as described in Reference Example 4.

The present invention is further illustrated by the following set of embodiments and combinations of embodiments resulting from the dependencies and back-references as indicated. In particular, it is noted that in each instance where a range of embodiments is mentioned, for example in the context of a term such as “The process of any one of embodiments 1 to 4”, every embodiment in this range is meant to be explicitly disclosed for the skilled person, i.e. the wording of this term is to be understood by the skilled person as being synonymous to “The process of any one of embodiments 1, 2, 3 and 4”. Further, it is explicitly noted that the following set of embodiments represents a suitably structured part of the general description directed to preferred aspects of the present invention, and, thus, suitably supports, but does not represent the claims of the present invention.
1. A process for purifying a pyrolysis oil, the process comprising:
   (i) providing a stream F0 comprising the pyrolysis oil;
   (ii) subjecting the stream F0 provided in (i) to extraction in at least one extraction zone Z_{E}, obtaining a stream F1 comprising the extracted pyrolysis oil, wherein (ii) comprises:
      (ii.1) introducing F0 into an extraction unit UM1 comprised in Z_{E};
      (ii.2) bringing in contact F0 with water and a base B in UM1 at a temperature T1 in the range of from 10 to 200° C., obtaining a mixture M1 comprising an aqueous phase P_{A}(1) and an organic phase P_{O}(1), the pH of the aqueous phase P_{A}(1) of M1 being in the range of from 7.5 to 11;
      (ii.3) passing the mixture M1 obtained according to (ii.2) into a liquid-liquid separation unit US1 comprised in Z_{E}, US1 being located downstream of UM1, obtaining a stream F_{A}(1) comprising P_{A}(1) and a stream F1 comprising P_{O}(1) being the extracted pyrolysis oil;
      (ii.4) removing F1 from Z_{E};
   (iii) subjecting the stream F1 provided in (ii) to washing in at least one washing zone Z_{W}, Z_{W} being located downstream of Z_{E}, obtaining a stream F2 comprising the purified pyrolysis oil.
2. The process of embodiment 1, wherein from 95 to 100 weight-%, preferably from 98 to 100 weight-%, more preferably from 99 to 100 weight-%, of F0 consist of pyrolysis oil.
3. The process of embodiment 1 or 2, wherein the pyrolysis oil according to (i) has an oxygen content in the range of from 0.5 to 15 g(O)/100 g (F0), preferably in the range of from 0.5 to 10 g(O)/100 g (F0), more preferably in the range of from 0.5 to 5 g(O)/100 g (F0), more preferably in the range of from 0.5 to 2 g(O)/100 g (F0), determined as described in Reference Example 4.
4. The process of any one of embodiments 1 to 3, wherein the pyrolysis oil according to (i) has a total acid number (TAN) in the range of from 0.5 to 60 mg KOH/g (F0), preferably 1 to 40 mg KOH/g (F0), preferably in the range of from 3 to 20 mg KOH/g (F0), determined as described in Reference Example 3.
5. The process of any one of embodiments 1 to 4, wherein the pyrolysis oil according to (i) has a total chlorine content in the range of from 30 to 3,000 wppm (ppm by weight), preferably from 30 to 500 wppm, more preferably from 30 to 300 wppm, determined as described in Reference Example 1.1;
wherein the pyrolysis oil according to (i) has a chloride content of at most 40 wppm, more preferably in the range of from 0 to 30 wppm, determined as described in Reference Example 1.2.
6. The process of any one of embodiments 1 to 5, wherein the pyrolysis oil according to (i) has a nitrogen content in the range of from 50 to 20,000 wppm (ppm by weight), preferably from 50 to 5,000 wppm, more preferably from 100 to 4,000 wppm, determined as described in Reference Example 2.
7. The process of any one of embodiments 1 to 6, wherein (ii.2) comprises
   (ii.2.1) introducing water into UM1 comprised in Z_{E};
   (ii.2.2) bringing in contact, preferably mixing, F0 with water into UM1, obtaining a mixture PM1 comprising water and the pyrolysis oil;
   (ii.2.3) introducing B into UM1 and bringing in contact, preferably mixing, B with the mixture PM1 obtained in (ii.2.2) into UM1, obtaining a mixture M1 comprising an aqueous phase P_{A}(1) and an organic phase P_{O}(1), the pH of the aqueous phase P_{A}(1) of M1 being in the range of from 7.5 to 11, preferably in the range of from 8 to 10;
   wherein preferably (ii.2) comprises
   (ii.2.1) introducing water into UM1 comprised in Z_{E};
   (ii.2.2) bringing in contact, preferably mixing, F0 with water into Z_{E}, obtaining a mixture PM1 comprising water and the pyrolysis oil, wherein the aqueous phase of PM1 having a pH value pH(PM1), preferably measured by a pH-sensor in UM1;
   (ii.2.3) adjusting the pH of the aqueous phase of PM1 by introducing B into UM1 by bringing in contact, preferably mixing, B with M1 obtained in (ii.2.2) into UM1, obtaining a mixture M1 comprising an aqueous phase P_{A}(1) and an organic phase P_{O}(1), the pH of the aqueous phase P_{A}(1) of M1>pH(PM1), the pH of P_{A}(1) being in the range of from 7.5 to 11, preferably in the range of from 8 to 10.
8. The process of any one of embodiments 1 to 6, wherein (ii.2) comprises
   (ii.2.1′) mixing water and B, obtaining a mixture M0 of water and B having a pH(M0) in the range of from 12 to 14;
   (ii.2.2′) introducing M0 obtained according to (ii.2.1′) into UM1 and bringing in contact, more preferably mixing, F0 with M0, obtaining a mixture M1 comprising an aqueous phase P_{A}(1) and an organic phase P_{O}(1), the pH of the aqueous phase P_{A}(1) of M1 being in the range of from 7.5 to 11, preferably in the range of from 8 to 10.
9. The process of any one of embodiments 1 to 8, wherein the extraction unit UM1 is one or more of a stirred vessel, a mixing pump and a static mixer, preferably a stirred vessel.
10. The process of any one of embodiments 1 to 9, wherein bringing in contact, preferably mixing, according to (ii.2) is performed at a temperature T1 in the range of from 10 to 95° C., preferably in the range of from 15 to 85° C., more preferably in the range of from 20 to 80° C.
11. The process of any one of embodiments 1 to 10, wherein the base B is one or more of an alkali metal compound, an alkaline earth metal compound and ammonia, preferably B is an alkali metal compound being one or more of potassium hydroxide, sodium hydroxide, potassium carbonate, sodium carbonate, potassium bicarbonate and sodium bicarbonate, more preferably one or more of potassium hydroxide, sodium hydroxide, potassium carbonate and sodium carbonate, more preferably one or more of potassium hydroxide and sodium hydroxide, more preferably potassium hydroxide or sodium hydroxide, more preferably potassium hydroxide.
12. The process of any one of embodiments 1 to 11, wherein water used in (ii) is demineralized water.
13. The process of any one of embodiments 1 to 12, wherein the liquid-liquid separation unit US1 is one or more of a hydrocyclone, a settler tank and a centrifuge, preferably a decanter, a hydrocyclone, a settler tank or a centrifuge, more preferably a settler tank.
14. The process of any one of embodiments 1 to 13, wherein the separation in US1 according to (ii.3) is performed at a temperature in the range of from 10 to 95° C., preferably in the range of from 15 to 85° C., more preferably in the range of from 20 to 80° C.
15. The process of any one of embodiments 1 to 14, wherein, prior to passing M1 into US1 according to (ii.3), the process further comprises passing M1 into a solid-liquid separation unit SLS1 for removing solids, if any, in M1.
16. The process of embodiment 15, wherein the solid-liquid separation unit SLS1 is one or more of a filter and a centrifuge.
17. The process of any one of embodiments 1 to 16, further comprising passing the stream F_{A}(1) comprising P_{A}(1) obtained according to (ii.3) in a separation unit USA1, preferably a settler tank, obtaining an aqueous stream SA1 comprising water.
18. The process of any one of embodiments 1 to 17, wherein no organic solvent is used in (ii).
19. The process of any one of embodiments 1 to 18, further comprising, when crud is formed at the interphase of P_{A}(1) and P_{O}(1) in US1, purging said crud from US1.
20. The process of any one of embodiments 1 to 19, wherein (iii) comprises
   (iii.1) introducing F1 into a washing unit UM2 comprised in Z_{W};
   (iii.2) bringing in contact F1 with water in UM2 at a temperature T2 in the range of from 10 to 95° C., obtaining a mixture M2 comprising an aqueous phase P_{A}(2) and an organic phase P_{O}(2), the pH of the aqueous phase P_{A}(2) of M2 being in the range of from 7.5 to 11, pH of P_{A}(2)<pH of P_{A}(1);
   (iii.3) passing the mixture M2 obtained according to (iii.2) into a liquid-liquid separation unit US2 comprised in Z_{W}, US2 being located downstream of UM2, obtaining a stream F_{A}(2) comprising P_{A}(2) and a stream F2 comprising P_{O}(2) being the purified pyrolysis oil.
21. The process of embodiment 20, wherein the washing unit UM2 is one or more of a stirred vessel, a mixing pump and a static mixer, more preferably a stirred vessel.
22. The process of embodiment 20 or 21, wherein, according to (iii.2), the weight ratio of water to F1 is in the range of from 0.05:1 to 2:1, preferably in the range of from 0.1:1 to 1.5:1, more preferably in the range of from 0.1:1 to 1.2:1, more preferably in the range of from 0.1:1 to 0.5:1 or more preferably in the range of from 0.8:1 to 1.2:1.
23. The process of any one of embodiments 20 to 22, wherein the liquid-liquid separation unit US2 is one or more of a hydrocyclone, a settler tank, and a centrifuge, preferably a hydrocyclone, a settler tank or a centrifuge, more preferably a settler tank or centrifuge.
24. The process of any one of embodiments 20 to 23, wherein the separation in US2 according to (iii.3) is performed at a temperature in the range of from 10 to 85° C., preferably in the range of from 15 to 85° C., more preferably in the range of from 20 to 80° C.
25. The process of any one of embodiments 20 to 24, wherein, prior to passing M2 into US2 according to (iii.3), the process further comprises passing M2 into a solid-liquid separation unit SLS2 for removing solids, if any, in M2.
26. The process of embodiment 25, wherein the solid-liquid separation unit SLS2 is one or more of a filter and a centrifuge.
27. The process of any one of embodiments 20 to 24, wherein, between UM2 and US2, no separation unit is located.
28. The process of any one of embodiments 1 to 19, wherein (iii) comprises
   (iii.1′) introducing F1 into an extraction column UM+US comprised in Z_{W};
   (iii.2′) introducing water into UM+US;
   (iii.3′) bringing in contact F1 with water in UM+US at a temperature T2′ in the range of from 10 to 95° C., obtaining a stream F_{A}(2) comprising an aqueous phase P_{A}(2), the pH of the aqueous phase P_{A}(2) of M2 being in the range of from 7.5 to 11, pH of P_{A}(2)<pH of P_{A}(1), and obtaining a stream F2 comprising the purified pyrolysis oil.
29. The process of embodiment 28, wherein, according to (iii.3′), the weight ratio of water to F1 is in the range of from 0.05:1 to 2:1, preferably in the range of from 0.1:1 to 1.5:1, more preferably in the range of from 0.1:1 to 1.2:1, more preferably in the range of from 0.1:1 to 0.5:1 or more preferably in the range of from 0.8:1 to 1.2:1.
30. The process of any one of embodiments 20 to 29, further comprising
   recycling at least a portion of water comprised in F_{A}(2) obtained according to (iii.3) in (ii.2) and/or (iii.2); or
   recycling at least a portion of water comprised in F_{A}(2) obtained according to (iii.3′) in (ii.2) and/or (iii.2′); and/or
   recycling at least a portion of water comprised in F_{A}(1) obtained according to (ii.3) in (ii.2).
31. The process of any one of embodiments 1 to 30, wherein no organic solvent is used in (iii).
32. The process of any one of embodiments 1 to 31, wherein the stream F2 comprising the purified pyrolysis oil obtained according to (iii) has a total acid number (TAN) which is lower than the TAN of the pyrolysis oil provided in (i).
33. The process of embodiment 32, wherein the stream F2 comprising the purified pyrolysis oil obtained according to (iii) has a TAN in the range of from 0 to 20 mg KOH/g (F2), more preferably in the range of from 0 to 10 mg KOH/g (F2), more preferably in the range of from 0 to 4 mg KOH/g (F2), determined as described in Reference Example 3.
34. The process of any one of embodiments 1 to 33, wherein the stream F2 comprising the purified pyrolysis oil obtained according to (iii) has an oxygen content equal to or lower than, more preferably lower than, the oxygen content of the pyrolysis oil provided in (i).
35. The process of embodiment 34, wherein the stream F2 comprising the purified pyrolysis oil has an oxygen content in the range of from 0 to 2 g(O)/100 g (F2), determined as described in Reference Example 4.
36. The process of any one of embodiments 1 to 35, as far as embodiment 36 depends on any one of embodiments 20 to 27, further comprising
   (iv) subjecting at least a portion of the stream F2 obtained according to (iii) to one or more subsequent washing in Z_{W}, wherein (iv) comprises:
      (iv.1) optionally introducing at least a portion of F2, preferably F2, obtained according to (iii) into a washing unit UM3 comprised in Z_{W}, UM3 being located downstream of US2;
         bringing in contact the at least portion of F2, preferably F2, with water in UM3 at a temperature T3 in the range of from 10 to 95° C., obtaining a mixture M3 comprising an aqueous phase P_{A}(3) and an organic phase P_{O}(3) of M3 being in the range of from 7.5 to 11, pH of P_{A}(3)<pH of P_{A}(1);
         passing the mixture M3 in a liquid-liquid separation unit US3 comprised in Z_{W}, US3 being located downstream of UM3, obtaining a stream F_{A}(3) comprising P_{A}(3) and a stream F3 comprising P_{O}(3) being the purified pyrolysis oil;
      (iv.2) introducing at least a portion of F2, preferably F2, obtained according to (iii), or at least a portion of F3, preferably F3, obtained according to (iv.1), into a washing unit UM4 comprised in Z_{W}, UM4 being located downstream of US3;
      (iv.3) bringing in contact the at least portion of F2, preferably F2, or the at least portion of F3, preferably F3, with water in UM4 at a temperature T4 in the range of from 10 to 95° C., obtaining a mixture M4 comprising an aqueous phase P_{A}(4) and an organic phase P_{O}(4), the pH of the aqueous phase P_{A}(4) of M4 being in the range of from 7.5 to 11, pH of P_{A}(4)<pH of P_{A}(1);
      (iv.4) passing the mixture M4 obtained according to (iv.3) in a liquid-liquid separation unit US4 comprised in Z_{W}, US4 being located downstream of UM4, obtaining a stream F_{A}(4) comprising P_{A}(4) and a stream F4 comprising P_{O}(4) being the purified pyrolysis oil.
37. The process of any one of embodiments 1 to 36, further comprising
   (v) introducing F2 comprising the pyrolysis oil obtained according to (iii), optionally F4 obtained according to (iv), into at least one storage unit SU and storing said pyrolysis oil in SU.
38. The process of embodiment 37, wherein the storage unit SU is a storage tank, preferably a storage tank made of one or more of steel and stainless steel, more preferably carbon steel and stainless steel.
39. The process of any one of embodiments 1 to 38, further comprising one or more of a dechlorination step, a hydrogenation step, a hydroprocessing step, a steam cracking step, a hydrocracking step, a distillation step, a stripping step, and an aqueous extraction step.
40. The process of any one of embodiments 1 to 39, being a continuous or semi-continuous process.
41. A unit for carrying out the process for purifying a pyrolysis oil according to any one of embodiments 1 to 40, the unit comprising
   at least one extraction zone Z_{E} comprising an extraction unit UM1 and a liquid-liquid separation unit US1, UM1 being located upstream of US1;
   an inlet means for introducing F0 into Z_{E};
   an outlet means for removing F1 from Z_{E};
   an inlet means for introducing F0 into UM1;
   an outlet means for removing M1 from UM1;
   an inlet means for introducing M1 into US1;
   an outlet means from removing F1 from US1;
   at least one washing zone Z_{W}, located downstream of Z_{E},
   an inlet means for introducing F1 into Z_{W};
   an outlet means for removing F2 from Z_{W}.
42. The unit of embodiment 41, wherein US1 comprises a means for purging the optional crud formed at the interphase of P_{A}(1) and P_{O}(1).
43. The unit of embodiment 41 or 42, wherein Z_{W} comprises
   a washing unit UM2;
   a liquid-liquid separation unit US2, UM2 being located upstream of US2;
   an inlet means for introducing F1 into UM2;
   an inlet means for introducing water into UM2;
   an outlet means for removing M2 from UM2;
   an inlet means for introducing M2 into US2;
   an outlet means from removing F2 from US2.
44. The unit of embodiment 43, wherein Z_{W} further comprises a washing unit UM4, preferably a mixing unit, and a liquid-liquid separation unit US4, UM4 being located downstream of US2 and US4 being located downstream of UM4;
   wherein optionally Z_{W} further comprises a washing unit UM3, preferably a mixing unit, and a liquid-liquid separation unit US3, UM3 being located downstream of US2 and upstream of UM4, US3 being located downstream of UM3 and upstream of UM4.
45. The unit of embodiment 41 or 42, wherein Z_{W} comprises
   an extraction column UM+US;
   an inlet means for introducing F1 into UM+US;
   an inlet means for introducing water into UM+US;
   an outlet means from removing F2 from UM+US.
46. The unit of any one of embodiments 41 to 45, further comprising one or more of a storage tank, a cracking zone, an adsorption zone, a dechlorination zone, an hydrogenation zone, a hydroprocessing zone, a stripping zone and a distillation zone.
47. Process comprising the step:
   using the unit according to any one of embodiments 41 to 46 to obtain a purified pyrolysis oil, monomer, polymer or polymer product.
48. Process, preferably comprising the steps according to any one of embodiments 1 to 40, comprising the further step:
   converting the stream F2 obtainable or obtained by the process according to any one of embodiments 1 to 40 or a chemical material obtainable by or obtained by the process according to any one of embodiments 1 to 40 to obtain a monomer, polymer or polymer product.
49. Process according to any one of embodiments 1 to 40 and/or 47 to 48,
   wherein the polymer or polymer product is a granulate, strand, rod, plate, pipe, foil, layer, film, sheet, fiber, filament, coating, extruded and/or molded article, soft foam, half-rigid foam and/or rigid foam.
50. Process according to any one of embodiments 1 to 40 and/or 47 to 49,
   wherein the monomer is a di- or polyol; preferably butandiol; aldehyde; preferably formaldehyde; di- or polyisocyanate; preferably methylene diphenyl diisocyanate (MDI), polymeric methylene diphenyl diisocyanate (pMDI), toluene diisocyanate (TDI), hexamethylenediisocyanate (HDI) or isophoronediisocyanate (IPDI); amide; preferably caprolactam; alkene; preferably styrene, ethene and norbornene; alkyne, (di) ester; preferably methyl methacrylate; mono or diacid; preferably adipic acid or terephthalic acid; diamine; preferably hexamethylenediamine, nonanediamine, or sulfones; preferably 4,4′-dichlorodiphenyl sulfone.
51. Process according to any one of embodiments 1 to 40 and/or 47 to 50,
   wherein the polymer is and/or the polymer product comprises polyamide (PA); preferably PA 6 and PA 66; polyisocyanate polyaddition product; preferably polyurethane (PU), themoplastic polyurethane (TPU), polyurea or polyisocyanurate (PIR); low-density polyethylene (LDPE), high-density polyethylene (HDPE), polyethylene (PE), polypropylene (PP), polyvinyl chloride (PVC), polyvinyl acetate (PVA), polystyrene (PS), poly acrylonitrile butadiene styrene (ABS), poly styrene acrylonitrile (SAN), poly acrylate styrene acrylonitrile (ASA), polytetrafluoroethylene (Teflon), thermoplastic polyurethanes (TPU), poly(methyl acrylate) (PMA), poly(methyl methacrylate) (PMMA), polybutadiene (BR, PBD), poly(cis1,4-isoprene), poly(trans-1,4-isoprene), polyoxymethylene (POM), polyethylene terephthalate (PET), polybutylene terephthalate (PBT), polybutylene adipate coterephthalate (PBAT), polyester (PES), polyether sulfone (PESU), polyhydroxyalkanoate (PHA), poly-3-hydroxybutyrate (P3HB), poly-4-hydroxybutyrate (P4HB), polyhydroxyvalerate (PHV), polyhydroxyhexanoate (PHH), polyhydroxyoctanoate (PHO), polylactic acid (PLA), polysulfone (PSU), polyphenylene sulfone (PPSU), polycarbonate (PC), polyether ether ketone (PEEK), poly(p-phenylene oxide) (PPO), poly(p-phenylene ether) (PPE); and copolymers and mixtures thereof.
52. Process according to any one of embodiments 1 to 40 and/or 47 to 51,
   wherein the polymer and/or the polymer product is/are or is/are a part of:
      a part of a car, preferably cylinder head cover, engine cover, housing for charge air cooler, charge air cooler flap, intake pipe, intake manifold, connector, gear wheel, fan wheel, cooling water box, housing or housing part for heat exchanger, coolant cooler, charge air cooler, thermostat, water pump, radiator, fastening part or part of battery system for electromobility, dashboard, steering column switch, seat, headrest, center console, transmission component, door module, car exterior for A, B, C or D pillar cover, spoiler, door handle, exterior mirror, windscreen wiper, windscreen wiper protection housing, decorative grill, cover strip, roof rail, window frame, sunroof frame, antenna panel, headlight and taillight, engine cover, cylinder head cover, intake manifold, airbag, or cushion;
      a cloth, preferably shirt, trousers, pullover, boot, shoe, shoe sole, tight or jacket;
      an electrical part, preferably electrical or electronic passive or active component, printed circuit board, printed circuit board, housing component, foil, line, switch, plug, socket, distributor, relay, resistor, capacitor, inductor, bobbin, lamp, diode, LED, transistor, connector, regulator, integrated circuit (IC), processor, controller, memory, sensor, connectors, microswitches, microbuttons, semiconductor, reflector housing for light-emitting diodes (LED), fastener for electrical or electronic component, spacer, bolt, strip, slide-in guide, screw, nut, film hinge, snap hooks (snap-in) or spring tongue;
      a consumer and/or pharmaceutical product, preferably tennis string, climbing rope, bristle, brush, artificial grass, 3D printing filament, grass trimmer, zipper, hook and loop fastener, paper machine clothing, extrusion coating, fishing line, fishing net, offshore line and rope, vial, syringe, ampoule, bottle, sliding element, spindle nut, chain conveyor, plain bearing, roller, wheel, gear, roller, ring gear, screw and spring dampers, hose, pipeline, cable sheathing, socket, switch, cable tie, fan wheel, carpet, box or bottle for cosmetics, mattress, cushion or insulation; and/or
      packaging for the food industry; preferably mono- or multi-layer blown film, cast film (mono- or multi-layer), biaxially stretched film, laminating film.
53. Process according to any one of embodiments 1 to 40 and/or 47 to 52,
   wherein the content of the pyrolysis oil comprised in stream F0 in the purified pyrolysis oil, monomer, polymer and/or polymer product is 1 weight-% or more, preferably 2 weight-% or more, more preferably 5 weight-% or more, more preferably 15 weight-% or more, more preferably 30 weight-% or more, more preferably 40 weight-% or more, more preferably 60 weight-% or more, more preferably 80 weight-% or more, more preferably 90 weight-% or more, more preferably 95 weight-% or more; and/or
   wherein the content of the pyrolysis oil comprised in stream F0 in the purified pyrolysis oil, monomer, polymer and/or polymer product is 100 weight-% or less, preferably 95 weight-% or less, more preferably 90 weight-% or less, more preferably 50 weight-% or less, more preferably 25 weight-% or less, more preferably 10 weight-% or less; and preferably wherein the content is determined based on identity preservation and/or segregation and/or mass balance and/or book and claim chain of custody models, preferably based on mass balance, preferably the International Sustainability and Carbon Certification (ISCC) standard.
54. A purified pyrolysis oil, obtainable or obtained by a process according to any one of embodiments 1 to 40.

It is explicitly noted that the above set of embodiments represents a suitably structured part of the general description directed to preferred aspects of the present invention, and, thus, suitably supports, but does not represent the claims of the present invention.

In the context of the present invention, the term “crud” refers to an electrostatic-, solid- or surface active stabilized layer, containing aqueous and organic phases, that most commonly accumulates at the aqueous/organic interface in the settlers of solvent-extraction processes as well known in the art.

In the context of the present invention, a term “X is one or more of A, B and C”, wherein X is a given feature and each of A, B and C stands for specific realization of said feature, is to be understood as disclosing that X is either A, or B, or C, or A and B, or A and C, or B and C, or A and B and C. In this regard, it is noted that the skilled person is capable of transfer to above abstract term to a concrete example, e.g. where X is a chemical element and A, B and C are concrete elements such as Li, Na, and K, or X is a temperature and A, B and C are concrete temperatures such as 10° C., 20° C., and 30° C. In this regard, it is further noted that the skilled person is capable of extending the above term to less specific realizations of said feature, e.g. “X is one or more of A and B” disclosing that X is either A, or B, or A and B, or to more specific realizations of said feature, e.g. “X is one or more of A, B, C and D”, disclosing that X is either A, or B, or C, or D, or A and B, or A and C, or A and D, or B and C, or B and D, or C and D, or A and B and C, or A and B and D, or B and C and D, or A and B and C and D.

The converting steps to obtain the monomer, polymer or polymer product may comprise one or more synthesis steps and can be performed by conventional synthesis and technics well known to a person skilled in the art. Independent of the person skilled in the art to assess novelty and inventive step of the independent claims, the person skilled in the art to perform the converting step is from the technical field(s) pyrolysis, gasification, remonomerization, depolymerization and/or synthesis and/or production of monomers, polymers and polymer compounds, and its further processing (e.g. extrusion, injection molding). Examples of the steps of the conversion are described in “Industrial Organic Chemistry”, 3. volume, Wiley-VCH, 1997; ISBN: 978-3-527-28838-0; “Kunststoffhandbuch”, 11 volumes in 17 sub-volumes, Carl Hanser Verlag, especially volume 6, “Polyamide”, 1. edition, 1966; volume 7, “Polyurethane”, 3. edition, 1993; and volume 8, “Polyester”, 1. edition 1973, “Industrial Organic Chemistry”, 3. volume, Wiley-VCH, 1997; ISBN: 978-3-527-28838-0, “Injection Molding Reference Guide, 4th edition, CreateSpace Independent Publishing Platform, 2011, ISBN: 978-1466407824, EP0989146 (A1), EP1460094 (A1), WO2006034800 (A1), EP1529792 (A1), WO2006042674 (A1), EP0364854 (A2), U.S. Pat. No. 5,506,275 (A), EP0897402 (A1), WO2015082316 (A1), WO2021021855 (A1), WO2021126938 (A1), WO2021021902 (A1), WO2021092311 (A1), WO2008155271 (A1), WO2013139827 (A1), each of which is incorporated herein by reference.

The present invention is further illustrated by the following examples.

### EXAMPLES

### Reference Example 1.1 Measurement of Total Chlorine Content (Wppm)

The sample is filtered with a 0.45 μm syringe filter before analysis. The chlorine content is determined by combustion of the respective sample at 1050° C. Resulting combustion gases, i.e., hydrogen chloride, are led into a cell in which coulometric titration is performed.

### Reference Example 1.2 Measurement of Chloride Content (Wppm)

The sample is filtered with a 0.45 μm syringe filter before analysis. The chloride content is determined by ion chromatography. Apparatus: Ion chromatograph 850 Professional (Metrohm) (Pre column: Metrosep A Supp4/5 S-Guard and Analytical column: Metrosep A Supp 5 250/4; Flow: 0.7 mL/min; Column temperature: 30° C.; Detector temperature: 40° C.; Inject volume: 25 μL; Suppressor MSM HC Rotor A). As Eluant: 3.2 mmol/L Na2CO3; 1.0 mmol/L NaHCO₃ and as Suppressor regenerant: 50 mmol/L sulfuric acid were used.

Sample preparation: 0.2 g-0.4 g of the sample were weighed and dissolved in 10 mL toluene. For analyte extraction, 10 mL deionized water were added. After centrifugation, the aqueous phase was extracted and analyzed. Samples with a concentration below the limit value of the method were spiked with 20 μg/L chloride standard solution (corresponding to a limit value of 1 mg/kg chloride in the sample) to check the recovery rate.

### Reference Example 2 Measurement of N Content (Wppm)

The nitrogen content is determined by combustion of the respective sample at 1000° C. NO contained in resulting combustion gases reacts with ozone so that NO₂* is formed. Relaxation of excited nitrogen species is detected by chemiluminescence detectors according to ASTM D4629 (N). Calibration range is from 0.5 wppm to 50 wppm. Samples with higher concentrations are diluted with xylene to be in calibration range.

### Reference Example 3 Determination of the Total Acid Number (TAN)

The total acid number was determined by titration with KOH according to ASTM D3242.

### Reference Example 4 Measurement of Oxygen Content (O-Content) (Weight-%)

The sample (1-10 mg) is pyrolyzed/reduced in a reductive gas atmosphere on a soot contact, the oxygen was converted hereby to carbon monoxide (CO). The carbon monoxide is detected and quantified via IR spectrometry. The analyzer used is elementary analyzer model rapid OXY Cube®.

### Reference Example 5 Corrosion Tests

Two corrosion coupons of steel material 1.0425 (DIN EN 10028-2) are stored in the tested pyrolysis oil at 60° C. and under nitrogen atmosphere. Every 7 days the samples are washed with water, xylene and water again, dried and weighed. The medium is exchanged with fresh pyrolysis oil and the samples are put back. After 4 cycles (28 days) the average linear corrosion rate* is calculated and the coupons were examined. The surfaces of the corrosion coupons are examined in accordance to DIN 50905 using a binocular microscope at 10-20× magnification to detect various corrosion phenomena, frequency, extent and distribution of localized corrosion as well as discoloration of the coupon surface, scale formation or corrosion products. The depth of localized corrosion, e.g. shallow pit corrosion, is measured by optical focusing with light microscopy.
vᵢ: average linear corrosion rate [mm/year]
Dm: weight loss [g]
F: surface of coupon [cm²]
r: density of material [g/cm³]
T: testing time [days]

### Reference Example 6 Measurement of Fe, Sn, Zn Contents (Wppm)

An aliquot of the sample of approx. 0.35-0.40 g was weighed and transferred into an automated acid digestion system. The digestion included the following steps:
Cracking of the sample with a mixture of H₂SO₄ and HNO₃ at approx. 320° C.
Complete digestion of organic remnants with a mixture of H₂SO₄, HNO₃, H₂O₂ and HClO₄ at approx. 160° C.
Removal of excess acids by evaporation almost to dryness.
Dissolution of the digested residue in 5% (v/v) hydrochloric acid by heating to boiling point.

The digestion was performed in duplicate. A blank was prepared in an analogous manner.

The measurements of Fe, Sn and Zn contents were determined in the digested solution via inductively couple plasma optical emission spectrometry (ICP-OES) employing external calibrations and blank subtraction. The result was the mean of both duplicates.

### Example 1 Process for Purifying a Pyrolysis Oil According to the Present Invention

A feed stream F0 comprising a pyrolysis oil having a total acid number (TAN) of about 8.5 mg KOH/g, a total chlorine content of 24 wppm, a chloride content <5 wppm, a nitrogen content of 0.5 wt.-% based on the weight of the pyrolysis oil and an oxygen content of 1 wt.-% based on the weight of the pyrolysis oil, a density of 916 kg/m³ and a viscosity of 6.4 mPas was subjected to extraction (1.1) with NaOH or (1.2) and (1.3) with KOH at pH 10 at T=30° C. To do so, F0 was introduced in a 1.3 L agitated glass vessel. Demineralized water was then added into the vessel (phase ratio v (demineralized water/pyro oil)=0.3 kg/kg) forming a mixture. The pH of the aqueous phase of the mixture was adjusted to 10 with 10% NaOH (1.1) or KOH (1.2 and 1.3). The obtained mixture was mixed for 15 min. For the mixture with NaOH, the mixture was transferred to a centrifuge. For the mixtures with KOH, said mixtures were settled for 5 (1.2) and 7 (1.3) minutes in the glass vessel of 1.3 L. The aqueous phase was thus separated after settling from the organic (oil) phase. The organic phase was analyzed.

After separation of the water phase of the neutralization step, demineralized water was further added to the organic phase for removing remaining salts/caustic (entrainment). Demineralized water was added with a phase ratio v (demineralized water/organic phase)=1 kg/kg. The obtained mixture water/organic (oil) phase was introduced into a settler (liquid/liquid separation unit). The aqueous phase was separated after settling from the organic phase, said washed organic phase was analyzed. Different settling durations were applied depending on the sample, for 1.1, it was 8 min; for 1.2 it was 6 min and for 1.3 it was 2.5 min. The results are listed in Table 1 below.

TABLE 1
Pyrolysis oil composition before extraction, after extraction and after washing

| | TAN | | S | O | N | Cl |
|---|---|---|---|---|---|---|
| Example | [mg KOH/kg] | pH* | [g/100 g] | [g/100 g] | [g/100 g] | [mg/kg] |
| F0 | 8.5 | 4.8** | 1.1 | 1 | 0.5 | 24 |
| 1.1 (after | 0.2 | 10.3 | 1.1 | 0.7 | — | 22 |
| neutralization) | | | | | | |
| 1.1 (after washing) | 0.20 | 7.9 | 1.1 | 0.7 | — | 22 |
| 1.2 (after | 0.1 | 10 | 1.1 | 0.9 | — | 23 |
| neutralization) | | | | | | |
| 1.2 (after washing) | 0.1 | 8.5 | 1.1 | 0.7 | — | 21 |
| 1.3. (after | — | 10 | 1 | 0.7 | 0.46 | 17 |
| neutralization) | | | | | | |
| 1.3. (after washing) | 0.56 | 8.3 | 1.1 | 0.6 | 0.44 | 14 |

*pH of the aqueous phase
** pH of the aqueous phase of F0 after F0 was simply washed with demineralized water “—” not measured/determined.

As may be taken from Table 1, the extraction+washing permits to purify the pyrolysis oil by reducing its TAN, its oxygen content as well as the N- and Cl-contents.

Corrosion test: Corrosion tests were performed as described in Reference Example 5 with the pyrolysis oil F0 and with the purified pyrolysis oil obtained after washing for samples 1.1, 1.2 and 1.3. The results are detailed in Tables 2 to 4 below.

TABLE 2
Corrosion test on 2 coupons of steel material
1.0425 (DIN EN 10028-2) with pyrolysis oil F0

| | Coupon's weight [g] | | | | vl | |
|---|---|---|---|---|---|---|
| material | 0 d | 7 d | 21 d | 28 d | [mm/y] | visual findings |
| 1.0425 | 15.6122 | 15.6121 | 15.609 | 15.6049 | 0.005 | deposit formation, local |
| (coupon 1) | | | | | | corrosion attacks, pitting |
| | | | | | | corrosion with a max. |
| | | | | | | depth of about. 10 μm |
| | | | | | | (corresponds to local |
| | | | | | | 0.13 mm/y |
| 1.0425 | 14.9556 | 14.9556 | 14.9522 | 14.9498 | 0.004 | deposit formation, local |
| (coupon 2) | | | | | | corrosion attacks, pitting |
| | | | | | | corrosion with a max. |
| | | | | | | depth of about. 10 μm |
| | | | | | | (corresponds to local |
| | | | | | | 0.13 mm/y) |

As may be taken from Table 2, the pyrolysis oil prior the purification treatment according to the present invention was corrosive. The local corrosion and pitting corrosion are not acceptable.

TABLE 3
Corrosion test on 2 coupons of steel material 1.0425 (DIN EN 10028-2) with purified
pyrolysis oil (sample 1.1 after washing) with reduced TAN and O content

| | Coupon's weight [g] | | | | vl | |
|---|---|---|---|---|---|---|
| material | 0 d | 7 d | 21 d | 28 d | [mm/y] | visual findings |
| 1.0425 | 14.8182 | 14.8179 | 14.818 | 14.818 | 0.000 | sporadic rust spots |
| (coupon 1) | | | | | | (superficial), otherwise |
| | | | | | | without finding -> no pitting |
| | | | | | | corrosion, no localized |
| | | | | | | corrosion |
| 1.0425 | 15.358 | 15.358 | 15.358 | 15.358 | 0.000 | sporadic rust spots |
| (coupon 2) | | | | | | (superficial), otherwise |
| | | | | | | without finding -> no pitting |
| | | | | | | corrosion, no localized |
| | | | | | | corrosion |

As may be taken from Table 3, the pyrolysis oil purified according to the present invention with NaOH reduces greatly the corrosion: reduction of the average linear corrosion vl of more than 99% and only sporadic rust spots (superficial). There is thus no pitting corrosion or local corrosion as opposed to the comparative example which demonstrates a clear improvement. Said purified pyrolysis oil does not affect the technical stability of the steel material (vl of less than 0.1 mm/y in combination with no pitting or localized corrosion).

TABLE 4
Corrosion test on 2 coupons of steel material 1.0425 (DIN EN 10028-2) with purified
pyrolysis oil (sample 1.2 after washing) with reduced TAN and O content

| | Coupon's weight [g] | | | | vl | |
|---|---|---|---|---|---|---|
| material | 0 d | 7 d | 21 d | 28 d | [mm/y] | visual findings |
| 1.0425 | 15.5421 | 15.5418 | 15.541 | 15.5408 | 0.001 | sporadic rust spots |
| (coupon 1) | | | | | | (superficial), otherwise |
| | | | | | | without finding -> no pitting |
| | | | | | | corrosion, no localized |
| | | | | | | corrosion |
| 1.0425 | 15.0653 | 15.065 | 15.0648 | 15.0644 | 0.001 | sporadic rust spots |
| (coupon 2) | | | | | | (superficial), otherwise |
| | | | | | | without finding -> no pitting |
| | | | | | | corrosion, no localized |
| | | | | | | corrosion |

As may be taken from Table 4, the pyrolysis oil purified according to the present invention with KOH reduces greatly the corrosion: reduction of the average linear corrosion vl of about 80% and only sporadic rust spots (superficial). There is thus no pitting corrosion or local corrosion as opposed to the comparative example which demonstrates a clear improvement. Said purified pyrolysis oil does not affect the technical stability of the steel material.

Therefore, it has been demonstrated that the pyrolysis oil prior the purification treatment according to the present invention was corrosive while the purified pyrolysis oil (TAN<1) permits to greatly reduce the corrosion and does not affect the technical stability of the steel material.

### Reference Example 7 Process for Purifying a Pyrolysis Oil not According to the Present Invention-Corrosion Testing

In order to identify the optimum conditions of purification, a further process has been conducted for purifying a pyrolysis oil. A feed stream F0 comprising a pyrolysis oil as in Example 1 was subjected to extraction with KOH at pH 7 at T=50° C. To do so, F0 was introduced in a 1.3 L agitated glass vessel. Demineralized water was then added into the vessel (phase ratio v (water/pyrolysis oil)=0.5 kg/kg) forming a mixture. The pH of the aqueous phase of the mixture was adjusted to 7.2 with 25 wt.-% KOH. The obtained mixture was mixed for 15 min. The obtained aqueous phase was separated after settling (for 2 minutes) from the organic phase. The organic phase was analyzed.

Again, a washing step was done. Demineralized water was added to the organic phase with a phase ratio v (demineralized water/organic phase)=0.5 kg/kg to remove salts and caustic entrainment from the pyrolysis oil. The results are listed in Table 5 below.

TABLE 5

| | | | S | O | N |
|---|---|---|---|---|---|
| | TAN | | [g/ | [g/ | [g/ |
| Ref. Example 5 | [mg KOH/kg] | pH* | 100 g] | 100 g] | 100 g] |
| F0 | 8.5 | 4.8** | 1.1 | 1 | 0.5 |
| after | 4.4 | 7.2 | 1.1 | 0.9 | 0.47 |
| neutralization | | | | | |
| after washing | 4.4 | 7.2 | 1.1 | 0.9 | 0.45 |

*pH of the aqueous phase
**pH of the aqueous phase of F0 after F0 was simply washed with demineralized water.

As may be taken from Table 5, at pH 7 the reduce of the TAN was much less.

Corrosion test: Corrosion tests were performed as described in Reference Example 5 with the pyrolysis oil F0 (cf. Table 2 above) and with the purified pyrolysis oil obtained not according to the present invention (different pH). The results are detailed in Table 6 below.

TABLE 6
Corrosion test on 2 coupons of steel material 1.0425 (DIN EN 10028-2) with
purified pyrolysis oil obtained not according to the present invention

| | Coupon's weight [g] | | | | vl | |
|---|---|---|---|---|---|---|
| material | 0 d | 7 d | 21 d | 28 d | [mm/y] | visual findings |
| 1.0425 | 15.4646 | 15.4646 | 15.4642 | 15.4634 | 0.001 | light corrosive |
| (coupon 1) | | | | | | attack, sporadic |
| | | | | | | beginning pitting |
| | | | | | | corrosion |
| | | | | | | with a depth |
| | | | | | | of <5 μm |
| 1.0425 | 15.286 | 15.286 | 15.2857 | 15.2852 | 0.001 | light corrosive |
| (coupon 2) | | | | | | attack, sporadic |
| | | | | | | beginning pitting |
| | | | | | | corrosion |
| | | | | | | with a depth |
| | | | | | | of <5 μm |

As may be taken from Table 6, the pyrolysis oil purified not according to the present invention with KOH at pH 7 reduces the average linear corrosion vl. However, the pyrolysis oil is more corrosive than the purified pyrolysis oils obtained according to the process of the present invention (cf. Tables 3 and 4 above). Even if vl has been reduced, the presence of local corrosion and pitting corrosion is not acceptable.

### Example 2 Process for Purifying a Pyrolysis Oil According to the Present Invention

A feed stream F0 comprising a pyrolysis oil having a total acid number (TAN) of 15.9 mg KOH/g, a total Fe content of 15 wppm, a Sn content 3 wppm, a Zn content of 5 wppm based on the weight of the pyrolysis oil, a density of 863 kg/m³ and a viscosity of 1.7 mPas was subjected to extraction with NaOH at pH 10 at T=25° C. To do so, F0 was introduced in a 1.3 L agitated glass vessel. Demineralized water was then added into the vessel (phase ratio v (demineralized water/pyro oil)=0.5 kg/kg) forming a mixture. The pH of the aqueous phase of the mixture was adjusted to 10 with 25% NaOH The obtained mixture was mixed for 15 min. For the mixture with NaOH, the mixture was transferred to a centrifuge. The aqueous phase was thus separated after settling from the organic (oil) phase. The organic phase was analyzed.

After separation of the water phase of the neutralization step, demineralized water was further added to the organic phase for removing remaining salts/caustic (entrainment). Demineralized water was added with a phase ratio v (demineralized water/organic phase)=1 kg/kg. The obtained mixture water/organic (oil) phase was introduced into a settler (liquid/liquid separation unit). The aqueous phase was separated after settling from the organic phase, said washed organic phase was analyzed. The results are listed in Table 7 below.

TABLE 7
Pyrolysis oil composition before extraction and after extraction

| | TAN | | Fe | Sn | Zn |
|---|---|---|---|---|---|
| Example | [mg KOH/kg] | pH* | [wppm] | [wppm] | [wppm] |
| F0 | 15.9 | 4.0** | 15 | 3 | 5 |
| after | 0.2 | 10.3 | 2 | 1 | <1 |
| neutralization | | | | | |

*pH of the aqueous phase
**pH of the aqueous phase of F0 after F0 was simply washed with demineralized water.

As may be taken from Table 7, the extraction (neutralization) permits to purify the pyrolysis oil by reducing its TAN as well as the Fe-, Sn- and Zn-contents.

Comparative Example 1 Process for Purifying a Pyrolysis Oil not According to the Present Invention

A feed stream F0 comprising a pyrolysis oil having a total acid number (TAN) of 7 mg KOH/g was subjected to a first washing step with demineralized water into a 250 ml glass bottle with a phase ratio of v (demin. water/pyrolysis oil (F0))=1 kg/kg. The mixture was shook. The pH of the aqueous phase of the mixture was of pH 4.3. The obtained mixture water/organic phase (oil) was introduced into a centrifuge. The aqueous phase was thus separated from the organic (oil) phase.

After separating of the water phase from the organic phase, demineralized water was further added to the organic phase for a second washing step. Demineralized water was added with a phase ratio v (demineralized water/organic phase)=1 kg/kg. The obtained mixture water/organic phase (oil) was introduced into a centrifuge. The aqueous phase was separated after from the organic phase. Finally, a third washing step was performed and the aqueous phase was separated with a centrifuge from the organic phase, said washed organic phase was analyzed. The results are listed in Table 3 below.

TABLE 8

| | TAN | |
|---|---|---|
| | [mg | |
| Comp. Example 1 | KOH/kg] | pH* |
| F0 | 7 | 4.3** |
| after first washing | 6.5 | 4.3 |
| after second washing | 6.2 | 4.4 |
| after third washing | 6.1 | 4.1 |

*pH of the aqueous phase
**pH of the aqueous phase of F0 after F0 was simply washed with demineralized water.

As may be taken from Table 8, washing steps are not sufficient for reducing the TAN number.

### Reference Example 8: Testing of Different Bases

In this example, pyrolysis oils (each of them having a total acid number (TAN) of about 8.5 mg KOH/g, a total chlorine content of 24 wppm, a chloride content <5 wppm, a nitrogen content of 0.5 wt.-% based on the weight of the pyrolysis oil and an oxygen content of 1 wt.-% based on the weight of the pyrolysis oil, a density of 916 kg/m³ and a viscosity of 6.4 mPas) have been extracted with NaOH or KOH in centrifuge glasses under the conditions detailed in Table 9. After the extraction, phase separation of these oils have been observed (cf. Table 9).

TABLE 9

| | Temperature | | | |
|---|---|---|---|---|
| | [° C.] | V(H₂O):V(F0) | pH | Phase separation visible |
| NaOH | 25 | 0.3 | 10.2 | No |
| | 25 | 0.5 | 10.1 | No |
| | 25 | 1 | 10 | No |
| | 25 | 2 | 10 | No |
| | 25 | 1 | 7.9 | Yes |
| | 25 | 1 | 9 | Yes |
| KOH | 25 | 1 | 10 | Yes |
| | 25 | 0.4 | 10 | Yes |

As may be taken from Table 9, using NaOH for the extraction of pyrolysis oil at a pH of about 10 lead to the formation of a solid such that no phase separation was visible in gravity field between the aqueous and the oil phase. A further centrifugation step was required to separate the Solid, the aqueous and the oil phase after extraction. When the pH during extraction was reduced, less solid formed and the phase separation between the aqueous and the oil phase was clearly visible-thus making it easy to separate the aqueous and the oil phase after extraction. Further, less solid formed at a pH of about 10 when using KOH for the extraction of pyrolysis oil. Without wanting to be bound by any theory, using NaOH for the extraction of pyrolysis oil may lead to the formation of sodium soaps (sodium salts of fatty acids) which are mostly solid and which thus hinder the phase separation of the aqueous and the oil phase after extraction, in contrast to potassium soaps (potassium salt of fatty acids) which are mostly liquid and thus do not hinder the phase separation of the aqueous and the oil phase after extraction. Therefore, KOH might be selected over NaOH to avoid these drawbacks.

### DESCRIPTION OF THE FIGURES

FIG. 1 is a schematic representation of a unit for carrying out the process for purifying a pyrolysis oil according to embodiments of the invention. The unit comprises an extraction zone Z_{E} comprising an extraction unit UM1 and a liquid-liquid separation unit US1, US1 being located downstream of UM1, and a washing zone Z_{W}, downstream of Z_{E}, comprising a washing unit UM2 and a liquid-liquid separation unit US2, US2 being located downstream of UM2. The stream F0 comprising a pyrolysis oil is introduced into UM1 together with water and a base B. F0, water and B are brought in contact in UM1 at a temperature in the range of from 10 to 200° C., preferably in the range of from 10 to 95° C. A mixture M1 is removed from UM1, said mixture comprising an aqueous phase P_{A}(1) and an organic phase P_{O}(1), the pH of the aqueous phase P_{A}(1) of M1 being in the range of from 7.5 to 11. M1 is introduced into US1. A stream F_{A}(1) comprising P_{A}(1) and a stream F1 comprising the extracted pyrolysis oil (P_{O}(1)) are obtained and removed from US1 and Z_{E}. Further, F1 is introduced into UM2 together with water. F1 and water are brought in contact at a temperature in the range of from 10 to 95° C. A mixture M2 is obtained, said mixture comprising an aqueous phase P_{A}(2) and an organic phase P_{O}(2), the pH of the aqueous phase P_{A}(2) of M2 being in the range of from 7.5 to 11, pH of P_{A}(2)<pH of P_{A}(1). M2 is then introduced into US2. A stream F2 comprising the purified pyrolysis oil is obtained. A further stream F_{A}(2) comprising P_{A}(2) is also obtained. F2 can then be stored or transferred for further treatment(s). Optionally, F_{A}(1), aqueous stream, and/or F_{A}(2), aqueous stream, are recycled (not shown) in UM1 and/or UM2. Optionally, if crud is formed at the interphase of P_{A}(1) and P_{O}(1), said crud is removed from US1 with a purge (not shown).

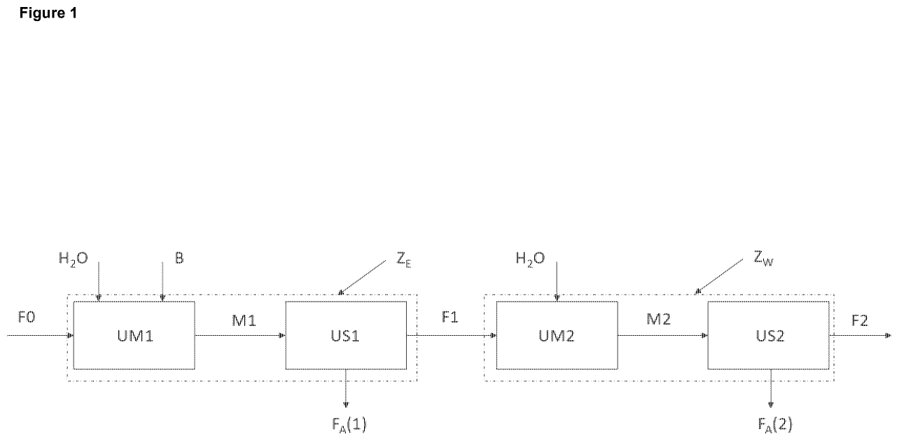

FIG. 2 is a schematic representation of a unit for carrying out the process for purifying a pyrolysis oil according to embodiments of the invention. The unit comprises an extraction zone Z_{E} comprising an extraction unit UM1, a solid-liquid separation unit SLS1 and a liquid-liquid separation unit US1, SLS1 being located downstream of UM1 and US1 being located downstream of SLS1, and a washing zone Z_{W}, downstream of Z_{E}, comprising a washing unit UM2, a solid-liquid separation unit SLS2 and a liquid-liquid separation unit US2, SLS2 being located downstream of UM2 and US2 being located downstream of SLS2. The process is as defined in FIG. 1, except that M1 prior to be introduced into US1 is passed through SLS1 to remove solids if any and that M2 prior to be introduced into US2 is passed through SLS2 to remove solids if any.

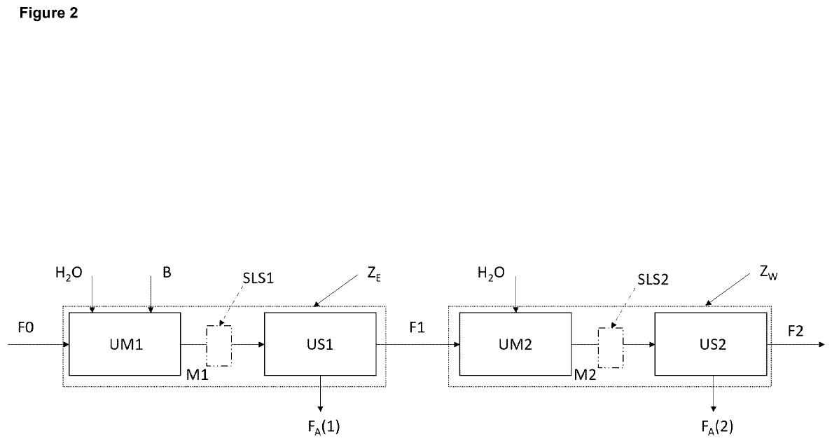

FIG. 3 is a schematic representation of a unit for carrying out the process for purifying a pyrolysis oil according to embodiments of the invention. The unit comprises an extraction zone Z_{E} comprising an extraction unit UM1 and a liquid-liquid separation unit US1, US1 being located downstream of UM1, and a washing zone Z_{W}, downstream of Z_{E}, comprising a washing unit UM2 combined to a liquid-liquid separation unit US2. Z_{E} optionally comprises a solid-liquid separation unit SLS1, located downstream of UM1 and upstream of US1. The stream F0 comprising a pyrolysis oil is introduced into UM1 together with water and a base B. F0, water and B are brought in contact in UM1 at a temperature in the range of from 10 to 200° C., preferably in the range of from 10 to 95° C. A mixture M1 is removed from UM1, said mixture comprising an aqueous phase P_{A}(1) and an organic phase P_{O}(1), the pH of the aqueous phase P_{A}(1) of M1 being in the range of from 7.5 to 11. M1 is introduced into US1. If SLS1 is present, M1 is passed through SLS1 prior to be introduced into US1. A stream F_{A}(1) comprising P_{A}(1) and a stream F1 comprising the extracted pyrolysis oil are obtained and removed from US1 and Z_{E}. Further, F1 is introduced into the combined UM2/US2 being an extraction column. Water is also introduced into said column and brought in contact with F1 at a temperature in the range of from 10 to 95° C., the phases of M2 are separated in the column, the pH of the aqueous phase P_{A}(2) of M2 being in the range of from 7.5 to 11, pH of P_{A}(2)<pH of P_{A}(1). A stream F2 comprising the purified pyrolysis oil is obtained (removed at the top of the column). A further stream F_{A}(2) comprising P_{A}(2) is also obtained (removed at the opposite of the column, namely the bottom). F2 can then be stored or transferred for further treatment(s). Optionally, F_{A}(2), aqueous stream, is recycled (not shown) in UM1 and/or Z_{W}.

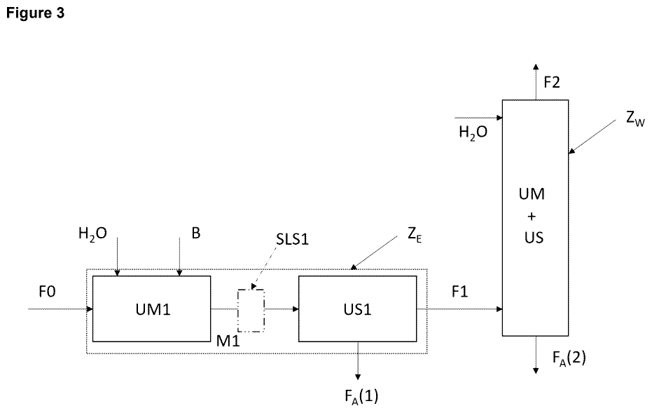

FIG. 4 is a schematic representation of a unit for carrying out the process for purifying a pyrolysis oil according to embodiments of the invention. The unit comprises an extraction zone Z_{E} comprising an extraction unit UM1, an optional solid-liquid separation unit SLS1 and a liquid-liquid separation unit US1, SLS1 being located downstream of UM1 and US1 being located downstream of SLS1, and a washing zone Z_{W}, downstream of Z_{E}, comprising a washing unit UM2, an optional solid-liquid separation unit SLS2 and a liquid-liquid separation unit US2, SLS2 being located downstream of UM2 and US2 being located downstream of SLS2. The process is as defined in FIG. 1, except that M1 prior to be introduced into US1 is optionally passed through SLS1 to remove solids if any and that M2 prior to be introduced into US2 is optionally passed through SLS2 to remove solids if any. Z_{W} of the unit further comprises a washing unit UM4, an optional solid-liquid separation unit SLS4 and a liquid-liquid separation unit US4, SLS4 being located downstream of UM4 and US4 being located downstream of SLS4. F2 is introduced into UM4 together with water. F2 and water are brought in contact at a temperature in the range of from 10 to 95° C. A mixture M4 is obtained, said mixture comprising an aqueous phase P_{A}(4) and an organic phase P_{O}(4), the pH of the aqueous phase P_{A}(4) of M4 being in the range of from 7.5 to 11, pH of P_{A}(4)<pH of P_{A}(1). M4 is then introduced into US4, and optionally passed through USL4 prior to be introduced into US4. A stream F4 comprising the purified pyrolysis oil is obtained. A further stream F_{A}(4) comprising P_{A}(4) is also obtained. F4 can then be stored or transferred for further treatment(s). Optionally, F_{A}(4), aqueous stream, is recycled (not shown) in UM2.

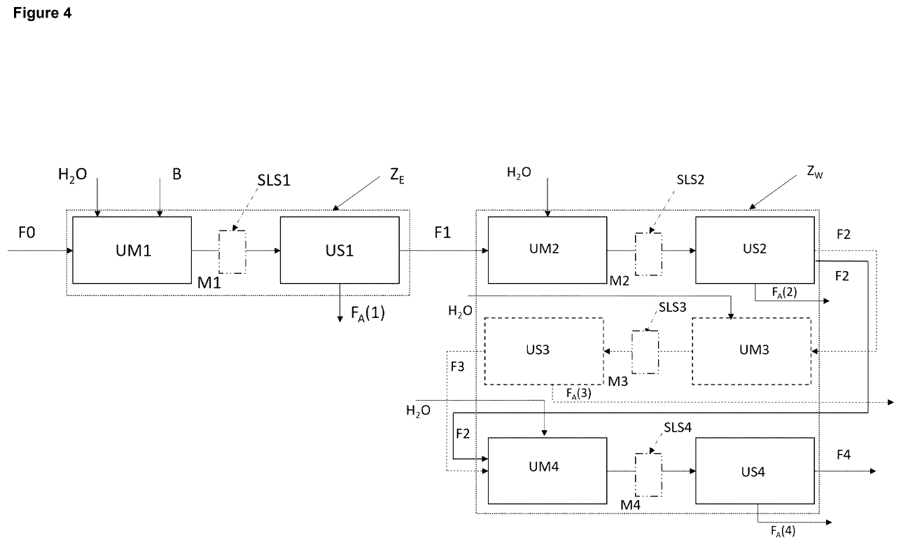

Optionally, Z_{W} of the unit further comprises a washing unit UM3 and a liquid-liquid separation unit US3, it can further comprises a solid-liquid separation unit SL3, SLS3 if present being located downstream of UM3 and US3 being located downstream of SLS3. Hence, F2 is introduced into UM3 (not UM4) together with water. F2 and water are brought in contact at a temperature in the range of from 10 to 95° C. A mixture M3 is obtained, said mixture comprising an aqueous phase P_{A}(3) and an organic phase P_{O}(3), the pH of the aqueous phase P_{A}(3) of M3 being in the range of from 7.5 to 11, pH of P_{A}(3)<pH of P_{A}(1). M3 is then introduced into US3, and optionally passed through USL3 prior to be introduced into US3. A stream F3 comprising the purified pyrolysis oil is obtained. A further stream F_{A}(3) comprising P_{A}(3) is also obtained. F3 is then introduced into UM4 together with water. F3 and water are brought in contact at a temperature in the range of from 10 to 95° C. A mixture M4 is obtained, said mixture comprising an aqueous phase P_{A}(4) and an organic phase P_{O}(4), the pH of the aqueous phase P_{A}(4) of M4 being in the range of from 7.5 to 11, pH of P_{A}(4)<pH of P_{A}(1). M4 is then introduced into US4, and optionally passed through USL4 prior to be introduced into US4. A stream F4 comprising the purified pyrolysis oil is obtained. A further stream F_{A}(4) comprising P_{A}(4) is also obtained. F4 can then be stored or transferred for further treatment(s). Optionally, F_{A}(4), aqueous stream, is recycled (not shown) in UM2 and/or UM3. Optionally, F_{A}(3), aqueous stream, is recycled (not shown) in UM2. Optionally, F_{A}(2), aqueous stream, is recycled (not shown) in UM1.

### Cited Literature

US 2021/0277324 A1
WO 2014/165859 A1
WO 2020/178599 A1

1.-25. (canceled)

26. A process for purifying a pyrolysis oil, the process comprising:
(i) providing a stream F0 comprising the pyrolysis oil;
(ii) subjecting the stream F0 provided in (i) to extraction in at least one extraction zone Z_{E}, obtaining a stream F1 comprising the extracted pyrolysis oil, wherein (ii) comprises:
(ii.1) introducing F0 into an extraction unit UM1 comprised in Z_{E};
(ii.2) bringing in contact F0 with water and a base B in UM1 at a temperature T1 in the range of from 10 to 200° C., obtaining a mixture M1 comprising an aqueous phase P_{A}(1) and an organic phase P_{O}(1), the pH of the aqueous phase P_{A}(1) of M1 being in the range of from 7.5 to 11;
(ii.3) passing the mixture M1 obtained according to (ii.2) in a liquid-liquid separation unit US1 comprised in Z_{E}, US1 being located downstream of UM1, obtaining a stream F_{A}(1) comprising P_{A}(1) and a stream F1 comprising P_{O}(1) being the extracted pyrolysis oil;
(ii.4) removing F1 from Z_{E};
(iii) subjecting the stream F1 provided in (ii) to washing in at least one washing zone Z_{W}, Z_{W} being located downstream of Z_{E}, obtaining a stream F2 comprising the purified pyrolysis oil.

27. The process of claim 26, wherein (ii.2) comprises
(ii.2.1) introducing water into UM1 comprised in Z_{E};
(ii.2.2) bringing in contact F0 with water in UM1, obtaining a mixture PM1 comprising water and the pyrolysis oil;
(ii.2.3) introducing B into UM1 and bringing in contact B with the mixture PM1 obtained in (ii.2.2) in UM1, obtaining a mixture M1 comprising an aqueous phase P_{A}(1) and an organic phase P_{O}(1), the pH of the aqueous phase P_{A}(1) of M1 being in the range of from 7.5 to 11.

28. The process of claim 26, wherein (ii.2) comprises
(ii.2.1′) mixing water and B, obtaining a mixture M0 of water and B having a pH(M0) in the range of from 12 to 14;
(ii.2.2′) introducing M0 obtained according to (ii.2.1′) into UM1 and bringing in contact F0 with M0 in UM1, obtaining a mixture M1 comprising an aqueous phase P_{A}(1) and an organic phase P_{O}(1), the pH of the aqueous phase P_{A}(1) of M1 being in the range of from 7.5 to 11.

29. The process of claim 26, wherein the extraction unit UM1 is one or more of a stirred vessel, a mixing pump and a static mixer.

30. The process of claim 26, wherein bringing in contact according to (ii.2) is performed at a temperature T1 in the range of from 10 to 95° C.

31. The process of claim 26, wherein the base B is one or more of an alkali metal compound, an alkaline earth metal compound and ammonia.

32. The process of claim 26, wherein no organic solvent is used in (ii).

33. The process of claim 26, wherein (iii) comprises:
(iii.1) introducing F1 into a washing unit UM2 comprised in Z_{W};
(iii.2) bringing in contact F1 with water in UM2 at a temperature T2 in the range of from 10 to 95° C., obtaining a mixture M2 comprising an aqueous phase P_{A}(2) and an organic phase P_{O}(2), the pH of the aqueous phase P_{A}(2) of M2 being in the range of from 7.5 to 11, pH of P_{A}(2)<pH of P_{A}(1);
(iii.3) passing the mixture M2 obtained according to (iii.2) in a liquid-liquid separation unit US2 comprised in Z_{W}, US2 being located downstream of UM2, obtaining a stream F_{A}(2) comprising P_{A}(2) and a stream F2 comprising P_{O}(2) being the purified pyrolysis oil.

34. The process of claim 33, wherein the washing unit UM2 is one or more of a stirred vessel, a mixing pump and a static mixer; and
wherein the liquid-liquid separation unit US2 is one or more of a hydrocyclone, a settler tank, a centrifuge and an extraction column.

35. The process of claim 26, wherein (iii) comprises:
(iii.1′) introducing F1 into an extraction column UM+US comprised in Z_{W};
(iii.2′) introducing water into UM+US;
(iii.3′) bringing in contact F1 with water in UM+US at a temperature T2′ in the range of from 10 to 95° C., obtaining a stream F_{A}(2) comprising an aqueous phase P_{A}(2), the pH of the aqueous phase P_{A}(2) of M2 being in the range of from 7.5 to 11, pH of P_{A}(2)<pH of P_{A}(1), and obtaining a stream F2 comprising the purified pyrolysis oil.

36. The process of claim 33, wherein, according to (iii.2) or (iii.3′), the weight ratio of water to F1 is in the range of from 0.05:1 to 2:1.

37. The process of claim 33, further comprising
recycling at least a portion of water comprised in F_{A}(2) obtained according to (iii.3) in (ii.2) and/or (iii.2); or
recycling at least a portion of water comprised in F_{A}(2) obtained according to (iii.3′) in (ii.2) and/or (iii.2′).

38. The process of claim 26, further comprising, when crud is formed at the interphase of P_{A}(1) and P_{O}(1) in US1, purging said crud from US1.

39. The process of claim 26, wherein the stream F2 comprising the purified pyrolysis oil obtained according to (iii) has a total acid number (TAN) which is lower than the TAN of the pyrolysis oil provided in (i).

40. The process of claim 26, further comprising
(iv) subjecting at least a portion of the stream F2 obtained according to (iii) to one or more subsequent washing in Z_{W}, wherein (iv) comprises:
(iv.1) optionally introducing at least a portion of F2 obtained according to (iii) into a washing unit UM3 comprised in Z_{W}, UM3 being located downstream of US2;
bringing in contact the at least portion of F2 with water in UM3 at a temperature T3 in the range of from 10 to 95° C., obtaining a mixture M3 comprising an aqueous phase P_{A}(3) and an organic phase P_{O}(3) of M3 being in the range of from 7.5 to 11, pH of P_{A}(3)<pH of P_{A}(1);
passing the mixture M3 in a liquid-liquid separation unit US3 comprised in Z_{W}, US3 being located downstream of UM3, obtaining a stream F_{A}(3) comprising P_{A}(3) and a stream F3 comprising P_{O}(3) being the purified pyrolysis oil;
(iv.2) introducing at least a portion of F2 obtained according to (iii), or at least a portion of F3 obtained according to (iv.1), into a washing unit UM4 comprised in Z_{W}, UM4 being located downstream of US3;
(iv.3) bringing in contact the at least portion of F2, or the at least portion of F3, with water in UM4 at a temperature T4 in the range of from 10 to 95° C., obtaining a mixture M4 comprising an aqueous phase P_{A}(4) and an organic phase P_{O}(4), the pH of the aqueous phase P_{A}(4) of M4 being in the range of from 7.5 to 11, pH of P_{A}(4)<pH of P_{A}(1);
(iv.4) passing the mixture M4 obtained according to (iv.3) in a liquid-liquid separation unit US4 comprised in Z_{W}, US4 being located downstream of UM4, obtaining a stream F_{A}(4) comprising P_{A}(4) and a stream F4 comprising P_{O}(4) being the purified pyrolysis oil.

41. A unit for carrying out the process for purifying a pyrolysis oil according to claim 26, the unit comprising
at least one extraction zone Z_{E} comprising an extraction unit UM1 and a liquid-liquid separation unit US1, UM1 being located upstream of US1;
an inlet means for introducing F0 into Z_{E};
an outlet means for removing F1 from Z_{E};
an inlet means for introducing F0 into UM1;
an outlet means for removing M1 from UM1;
an inlet means for introducing M1 into US1;
an outlet means from removing F1 from US1;
at least one washing zone Z_{W}, located downstream of Z_{E};
an inlet means for introducing F1 into Z_{W};
an outlet means for removing F2 from Z_{W}.

42. A purified pyrolysis oil, obtained by the process according to claim 26.

43. Process comprising the step:
using the unit according to claim 41 to obtain a purified pyrolysis oil, monomer, polymer or polymer product.

44. The process according to claim 26, comprising the further step:
converting the stream F2 obtained by the process according to claim 26 or a chemical material obtained by the process according to claim 26 to obtain a monomer, polymer or polymer product.

45. Process according to claim 44,
wherein the polymer or polymer product is a granulate, strand, rod, plate, pipe, foil, layer, film, sheet, fiber, filament, coating, extruded and/or molded article, soft foam, half-rigid foam and/or rigid foam.
